(19) United States
(12) Patent Application Publication
(10) Pub. No.: US 2025/0253530 A1
(43) Pub. Date: Aug. 7, 2025

(54) ANTENNA STRUCTURE AND ELECTRONIC DEVICE

(71) Applicant: HUAWEI TECHNOLOGIES CO., LTD., Shenzhen (CN)

(72) Inventors: Jiquan Guo, Wuhan (CN); Pengfei Wu, Shanghai (CN); Zhaoxuan Liu, Wuhan (CN); Jun You, Wuhan (CN)

(73) Assignee: HUAWEI TECHNOLOGIES CO., LTD., Shenzhen (CN)

(21) Appl. No.: 19/088,430

(22) Filed: Mar. 24, 2025

Related U.S. Application Data
(63) Continuation of application No. PCT/CN2023/118661, filed on Sep. 13, 2023.

(30) Foreign Application Priority Data
Sep. 23, 2022 (CN) 202211166885.3

(51) Int. Cl. H01Q 5/371; H01Q 5/48

(52) U.S. Cl. CPC H01Q 5/371; H01Q 5/48

(57) ABSTRACT

An antenna structure includes a first antenna, a second antenna, and a feeding point. A first radiator and a second radiator of the first antenna are axially symmetrically disposed relative to a perpendicular bisector between a first connection point and a second connection point. The other end of the first radiator and the other end of the second radiator are separately disposed in an extension manner in directions that are away from each other. One end of a second transmission line of the second antenna is electrically connected to the feeding point. The other end of the second transmission line is electrically connected to one end of a third radiator of the second antenna. The other end of the third radiator is grounded.

### CROSS-REFERENCE TO RELATED APPLICATIONS

This application is a continuation of International Application No. PCT/CN2023/118661, filed on Sep. 13, 2023, which claims priority to Chinese Patent Application No. 202211166885.3, filed on Sep. 23, 2022. The disclosures of the aforementioned applications are hereby incorporated by reference in their entireties.

### TECHNICAL FIELD

Embodiments of this application relate to the field of communication technologies, and in particular, to an antenna structure and an electronic device.

### BACKGROUND

An antenna is a component that performs an energy conversion function and directionally radiates or receives an electromagnetic wave in wireless communication. With rapid development of wireless communication technologies, more requirements are imposed on the antenna. For example, for a terminal product, there is a strict requirement on a specific absorption rate (SAR) value of the product. The SAR means electromagnetic radiation energy absorbed by a material of a unit mass in a unit time. Usually, the SAR value is used to measure a thermal effect of radiation of a terminal. Radiation of a mobile phone is used as an example. The SAR may be a rate of radiation absorbed by a human body (for example, the head). A smaller SAR value indicates less radiation absorbed by the human body.

In some implementations, to enable the SAR value to meet a regulatory requirement, a small SAR value is usually implemented by adjusting a size of a gap between an antenna radiator and a coupling unit. However, the antenna radiator and the coupling unit together form the entire antenna, and after the gap between the antenna radiator and the coupling unit is adjusted, an operating frequency band of an antenna structure is affected. As a result, the antenna structure cannot support simultaneous working at a low frequency (LF), a medium frequency (MF), and a high frequency (HF).

### SUMMARY

Embodiments of this application provide an antenna structure and an electronic device, to implement simultaneous working at a low frequency, a medium frequency, and a high frequency, meet a requirement on a small SAR value, and resolve a problem that antennas cannot work simultaneously at the low frequency, the medium frequency, and the high frequency when a SAR is low.

A first aspect of this application provides an antenna structure, including a first antenna, a second antenna, and a feeding point. The first antenna includes a first radiator, a second radiator, a first transmission line, a first matching circuit, and a second matching circuit. The first transmission line has an intersection point, a first connection point, and a second connection point. The intersection point is electrically connected to the feeding point. One end of the first radiator is electrically connected to the first connection point. One end of the second radiator is electrically connected to the second connection point. The other end of the first radiator and the other end of the second radiator are separately disposed in an extension manner in directions that are away from each other. The first radiator and the second radiator are symmetric relative to a perpendicular bisector between the first connection point and the second connection point. The intersection point is located on the perpendicular bisector. One end of the first matching circuit is electrically connected to the first transmission line located on a side on which the first connection point is located. The other end of the first matching circuit is grounded. One end of the second matching circuit is electrically connected to the first transmission line located on a side on which the second connection point is located. The other end of the second matching circuit is grounded. The second antenna includes a third radiator and a second transmission line. One end of the second transmission line is electrically connected to the feeding point. The other end of the second transmission line is electrically connected to one end of the third radiator. The other end of the third radiator is grounded.

The antenna structure provided in this embodiment of this application includes the first antenna, the second antenna, and the feeding point. The first antenna includes the first radiator, the second radiator, the first transmission line, the first matching circuit, and the second matching circuit. The first transmission line has the intersection point, the first connection point, and the second connection point. The intersection point is electrically connected to the feeding point. The end of the first radiator is electrically connected to the first connection point. The end of the second radiator is electrically connected to the second connection point. The other end of the first radiator and the other end of the second radiator are separately disposed in the extension manner in the directions that are away from each other. The first radiator and the second radiator are symmetric relative to the perpendicular bisector between the first connection point and the second connection point. The intersection point is located on the perpendicular bisector. In this way, the first antenna has two independent and symmetric radiators, namely, the first radiator and the second radiator. The first radiator and the second radiator cooperate with the first matching circuit and the second matching circuit, so that the first antenna can support an operating frequency band corresponding to medium and high frequencies. In addition, the independent first radiator and second radiator are symmetrically distributed relative to the feeding center of the first transmission line (namely, a location at which the perpendicular bisector between the first connection point and the second connection point intersects with the first transmission line). When a current is fed into the first radiator and the second radiator from the first transmission line, a current on the first radiator and a current on the second radiator radiate outward in directions that are away from each other. As a result, two formed hot points (locations at which the currents on the radiators are concentrated) are not concentrated together, to implement an effect of hot point dispersion.

In addition, the second antenna includes the third radiator and the second transmission line. The end of the second transmission line is electrically connected to the feeding point. The other end of the second transmission line is electrically connected to the end of the third radiator. The other end of the third radiator is grounded. In this way, the first antenna and the second antenna share one feeding point, and the first antenna and the second antenna respectively have the first transmission line and the second transmission line. As a result, the second antenna can support an operating frequency band corresponding to a low frequency. In this way, the antenna structure provided in this embodiment of this application is an antenna structure that supports all LF, MF, and HF frequency bands. After the current is fed from the feeding point, the current is fed into the first radiator and the second radiator through the first transmission line, and is fed into the third radiator through the second transmission line. The two mutually independent radiators of the first antenna form two dispersed hot points, and the two dispersed hot points and a hot point formed by the third radiator are not concentrated on one radiator, to achieve a purpose of hot point dispersion. This implements a feature of a low SAR, achieves an effect of good performance in an over the air (OTA) test, and avoids a case in which the hot points formed by the antenna radiators are concentrated on one radiator, and consequently radiation power is excessively high and a requirement on a SAR value cannot be met.

Therefore, according to the antenna structure provided in this application, a requirement on the low SAR is met by using a structural design of the first radiator and the second radiator in MF and HF operating bandwidths. An additional technology or component, for example, fixed reduction of power of a hot point, antenna switching (Transmit Antenna Select, TAS), SAR reduction of a receiver, or a capacitive SAR sensor is not required. Therefore, in this embodiment of this application, a design of the low SAR at low costs is implemented. In addition, when the feature of the low SAR is implemented, the effect of good performance in the over the air (OTA) test is achieved, and the case in which the hot points formed by the antenna radiators are concentrated on the radiator, and consequently the radiation power is excessively high and the requirement on the SAR value cannot be met is avoided.

In a possible implementation, the second matching circuit is the same as the first matching circuit, and the second matching circuit and the first matching circuit are symmetrically disposed relative to the perpendicular bisector.

In a possible implementation, the first matching circuit includes a first capacitor and a first inductor. The first capacitor and the first inductor are disposed in parallel. One end of the first capacitor and one end of the first inductor are both electrically connected to the first transmission line on the side on which the first connection point is located. The other end of the first capacitor and the other end of the first inductor are both grounded.

In a possible implementation, the second matching circuit includes a second capacitor and a second inductor. The second capacitor and the second inductor are disposed in parallel. One end of the second capacitor and one end of the second inductor are both electrically connected to the first transmission line located on the side on which the second connection point is located. The other end of the second capacitor and the other end of the second inductor are both grounded.

In a possible implementation, the first capacitor and the second capacitor are axially symmetrically disposed relative to the perpendicular bisector.

The first inductor and the second inductor are symmetrically disposed relative to the perpendicular bisector.

In a possible implementation, the first transmission line includes a first branch transmission section and a second branch transmission section. The first connection point is located in the first branch transmission section. The second connection point is located in the second branch transmission section.

One end of the first branch transmission section and one end of the second branch transmission section are both electrically connected to the intersection point. The other end of the first branch transmission section and the other end of the second branch transmission section are respectively electrically connected to the first matching circuit and the second matching circuit.

In a possible implementation, the first transmission line further includes a general transmission section. One end of the general transmission section is electrically connected to the feeding point. The other end of the general transmission section, one end of the first branch transmission section, and one end of the second branch transmission section intersect to form the intersection point.

In a possible implementation, the first connection point, the second connection point, and the intersection point are located on a same straight line.

In a possible implementation, an included angle between a connection line between the first connection point and the intersection point and a connection line between the second connection point and the intersection point exists on the first transmission line.

In a possible implementation, the first antenna further includes a first switch. The first switch is located on a connection link between the first radiator and the first connection point.

In a possible implementation, the first antenna further includes a second switch. The second switch is located on a connection link between the second radiator and the second connection point.

In a possible implementation, the second antenna further includes a third switch. One end of the third switch is electrically connected to the third radiator. The other end of the third switch is grounded, or the other end of the third radiator is grounded through the third switch.

In a possible implementation, the antenna structure further includes a circuit board. The first transmission line, the second transmission line, the first matching circuit, the second matching circuit, and the feeding point are all located on the circuit board.

The first radiator, the second radiator, and the third radiator are located on an outer side of an edge of the circuit board.

In a possible implementation, the first radiator, the second radiator, and the third radiator are located on a same side of an outer edge of the circuit board.

The first radiator is located between the second radiator and the third radiator.

Alternatively, the second radiator is located between the first radiator and the third radiator.

In a possible implementation, the first radiator and the second radiator are respectively located on two adjacent sides of the circuit board.

In a possible implementation, the first radiator and the second radiator each include a first vertical stub and a first horizontal stub. One end of the first vertical stub is electrically connected to the first horizontal stub.

In a possible implementation, the first radiator and the second radiator each further include a second vertical stub. One end of the second vertical stub is electrically connected to the first horizontal stub. The other end of the second vertical stub faces the first transmission line.

In a possible implementation, the first radiator and the second radiator further each include a second horizontal stub. One end of the second horizontal stub is electrically connected to the second vertical stub. The other end of the second horizontal stub faces the first vertical stub. There is an interval between the other end of the second horizontal stub and the first vertical stub.

In a possible implementation, the third radiator includes a third horizontal stub, a third vertical stub, and a fourth vertical stub. One end of the third vertical stub and one end of the fourth vertical stub are electrically connected to the third horizontal stub. The other end of the third vertical stub is electrically connected to the second transmission line. The other end of the fourth vertical stub is grounded.

In a possible implementation, the third radiator further includes a fifth vertical stub. The fifth vertical stub is located between the third vertical stub and the fourth vertical stub. One end of the fifth vertical stub is electrically connected to the third horizontal stub. The other end of the fifth vertical stub is grounded.

In a possible implementation, the third radiator includes a fourth horizontal stub, a fifth horizontal stub, a sixth horizontal stub, a sixth vertical stub, and a seventh vertical stub.

Two ends of the fourth horizontal stub are respectively electrically connected to the sixth vertical stub and the seventh vertical stub. The other end of the sixth vertical stub and the other end of the seventh vertical stub are respectively electrically connected to one end of the fifth horizontal stub and one end of the sixth horizontal stub.

The other end of the fifth horizontal stub is electrically connected to the second transmission line. The other end of the sixth horizontal stub is grounded.

In a possible implementation, an operating frequency band of the first antenna is a medium and high frequency band, and an operating frequency band of the second antenna is a low frequency band.

In a possible implementation, the medium and high frequency band ranges from 1710 MHz to 2690 MHz, and the low frequency band ranges from 698 MHz to 960 MHz.

In a possible implementation, the first transmission line and the second transmission line are microstrips or cables.

A second aspect of embodiments of this application provides an electronic device, including the antenna structure according to any one of the aspect and the possible implementations. By using the antenna structure, the electronic device supports simultaneous working in all LF, MF, and HF frequency bands, and a feature of a low SAR is implemented.

### BRIEF DESCRIPTION OF DRAWINGS

FIG. 1A is a schematic diagram of a structure of an antenna structure according to an embodiment of this application;

FIG. 1B is a schematic diagram of a structure of an antenna structure according to an embodiment of this application;

FIG. 1C is a schematic diagram of a structure of an antenna structure according to an embodiment of this application;

FIG. 2 is a schematic diagram of a structure of an antenna structure according to an embodiment of this application;

FIG. 3 is a schematic diagram of a structure of an antenna structure according to an embodiment of this application;

FIG. 4 is a schematic diagram of a structure of an antenna structure according to an embodiment of this application;

FIG. 5 is a schematic diagram of a structure of an antenna structure according to an embodiment of this application;

FIG. 6 is a schematic diagram of a structure of an antenna structure according to an embodiment of this application;

FIG. 7 is a schematic diagram of a structure of an antenna structure according to an embodiment of this application;

FIG. 8 is a schematic diagram of a structure of an antenna structure according to an embodiment of this application;

FIG. 9 is a schematic diagram of a structure of an antenna structure according to an embodiment of this application;

FIG. 10 is a schematic diagram of a structure of an antenna structure according to an embodiment of this application;

FIG. 11 is a schematic diagram of a structure of an antenna structure according to an embodiment of this application;

FIG. 12 is a schematic diagram of a structure of an antenna structure according to an embodiment of this application;

FIG. 13 is a schematic diagram of simulation of an antenna structure according to an embodiment of this application;

FIG. 14 is a schematic diagram of a Smith circle diagram of an antenna structure according to an embodiment of this application;

FIG. 15 is a current distribution diagram obtained when an antenna structure works at 0.7984 GHz according to an embodiment of this application;

FIG. 16 is a current distribution diagram of a first radiator and a second radiator when an antenna structure works at 1.6304 GHz according to an embodiment of this application;

FIG. 17 is a current distribution diagram of a third radiator when an antenna structure works at 1.6304 GHz according to an embodiment of this application;

FIG. 18 is a current distribution diagram of a first radiator and a second radiator when an antenna structure works at 1.6816 GHz according to an embodiment of this application;

FIG. 19 is a current distribution diagram of a third radiator when an antenna structure works at 1.6816 GHz according to an embodiment of this application;

FIG. 20 is a current distribution diagram of a first radiator and a second radiator when an antenna structure works at 1.8288 GHz according to an embodiment of this application;

FIG. 21 is a current distribution diagram of a third radiator when an antenna structure works at 1.8288 GHz according to an embodiment of this application;

FIG. 22 is a current distribution diagram of a first radiator and a second radiator when an antenna structure works at 2.4624 GHz according to an embodiment of this application;

FIG. 23 is a current distribution diagram of a third radiator when an antenna structure works at 2.4624 GHz according to an embodiment of this application;

FIG. 24 is a current distribution diagram of a first radiator and a second radiator when an antenna structure works at 2.5904 GHz according to an embodiment of this application;

FIG. 25 is a current distribution diagram of a third radiator when an antenna structure works at 2.5904 GHz according to an embodiment of this application;

FIG. 26 is a current distribution diagram of a first radiator and a second radiator when an antenna structure works at 2.68 GHz according to an embodiment of this application;

FIG. 27 is a current distribution diagram of a third radiator when an antenna structure works at 2.684 GHz according to an embodiment of this application;

FIG. 28 is a schematic diagram of simulation of an antenna structure in different frequency bands according to an embodiment of this application;

FIG. 29 is a schematic diagram of another structure of an antenna structure according to an embodiment of this application;

FIG. 30 is a schematic diagram of still another structure of an antenna structure according to an embodiment of this application;

FIG. 31 is a schematic diagram of simulation of an antenna structure according to an embodiment of this application;

FIG. 32 is a schematic diagram of a Smith circle diagram of an antenna structure according to an embodiment of this application;

FIG. 33 is a current distribution diagram obtained when an antenna structure works at 0.812 GHz according to an embodiment of this application;

FIG. 34 is a current distribution diagram of a first radiator and a second radiator when an antenna structure works at 1.589 GHz according to an embodiment of this application;

FIG. 35 is a current distribution diagram of a third radiator when an antenna structure works at 1.589 GHz according to an embodiment of this application;

FIG. 36 is a current distribution diagram of a first radiator and a second radiator when an antenna structure works at 1.694 GHz according to an embodiment of this application;

FIG. 37 is a current distribution diagram of a third radiator when an antenna structure works at 1.694 GHz according to an embodiment of this application;

FIG. 38 is a current distribution diagram of a first radiator and a second radiator when an antenna structure works at 1.82 GHz according to an embodiment of this application;

FIG. 39 is a current distribution diagram of a third radiator when an antenna structure works at 1.82 GHz according to an embodiment of this application;

FIG. 40 is a current distribution diagram of a first radiator and a second radiator when an antenna structure works at 2.128 GHz according to an embodiment of this application;

FIG. 41 is a current distribution diagram of a third radiator when an antenna structure works at 2.128 GHz according to an embodiment of this application;

FIG. 42 is a current distribution diagram of a first radiator and a second radiator when an antenna structure works at 2.366 GHz according to an embodiment of this application;

FIG. 43 is a current distribution diagram of a third radiator when an antenna structure works at 2.366 GHz according to an embodiment of this application;

FIG. 44 is a current distribution diagram of a first radiator and a second radiator when an antenna structure works at 2.562 GHz according to an embodiment of this application;

FIG. 45 is a current distribution diagram of a third radiator when an antenna structure works at 2.562 GHz according to an embodiment of this application;

FIG. 46 is a current distribution diagram of a first radiator and a second radiator when an antenna structure works at 2.667 GHz according to an embodiment of this application;

FIG. 47 is a current distribution diagram of a third radiator when an antenna structure works at 2.667 GHz according to an embodiment of this application;

FIG. 48 is a current distribution diagram of a first radiator and a second radiator when an antenna structure works at 2.772 GHz according to an embodiment of this application; and

FIG. 49 is a current distribution diagram of a third radiator when an antenna structure works at 2.772 GHz according to an embodiment of this application.

### DESCRIPTIONS OF REFERENCE NUMERALS

100: antenna structure;
110: first antenna; 111: first radiator; 1111 and 1121: first vertical stubs; 1112 and 1122: first horizontal stubs; 1113 and 1123: second vertical stubs; 1114 and 1124: second horizontal stubs; 112: second radiator;
113: first transmission line; 1131: first branch transmission section; 1132: second branch transmission section; 1133: general transmission section;
114: first matching circuit; 1141: first capacitor; 1142: first inductor; 115: second matching circuit; 1151: second capacitor; 1152: second inductor; 116: first switch; 117: second switch;
120: second antenna; 121: third radiator; 1211: third horizontal stub; 1212: third vertical stub; 1213: fourth vertical stub; 1214: fifth vertical stub; 1215: fourth horizontal stub; 1216: fifth horizontal stub; 1217: sixth horizontal stub; 1218: sixth vertical stub; 1219: seventh vertical stub; 122: second transmission line; 123: third switch;
130: circuit board;
140: feeding point.

### DESCRIPTION OF EMBODIMENTS

Embodiments of this application provide an antenna structure. When the antenna structure is used in an electronic device, a specific absorption rate (Specific Absorption Ration, SAR) value of the electronic device is usually tested. A smaller SAR value indicates a smaller amount of radiation absorbed by a human body. The SAR value can measure an amount of radiation of the electronic device to a user. Therefore, the SAR value of the electronic device needs to meet a regulatory requirement. In some applications, to enable the SAR value to meet the regulatory requirement, usually, a size of a gap between an antenna radiator and a coupling unit in an antenna structure 100 is adjusted. An energy radiation direction of an antenna is changed by adjusting the size of the gap, to reduce a SAR value of the antenna. However, after the size of the gap between the antenna radiator and the coupling unit is adjusted, an operating frequency band of the antenna structure is affected. As a result, the antenna structure cannot support simultaneous working at a low frequency (LF), a medium frequency (MF), and a high frequency (HF).

To resolve at least one of the foregoing problems, embodiments of this application provide an antenna structure. A first antenna and a second antenna share a feeding point, and the first antenna and the second antenna respectively have a first transmission line and a second transmission line that correspond to the first antenna and the second antenna, so that the second antenna can support an operating frequency band corresponding to a low frequency, and the first antenna supports an operating frequency band corresponding to medium and high frequencies. In this way, the antenna structure provided in embodiments of this application is an antenna structure that supports all LF, MF, and HF frequency bands. After a current is fed from the feeding point, the current is fed, through the first transmission line, into a first radiator and a second radiator that are symmetric, and is fed into a third radiator through the second transmission line. Two mutually independent and symmetric radiators of the first antenna are far away from each other. In this way, two dispersed hot points are formed, and the two dispersed hot points and a hot point formed by the third radiator are not concentrated on one radiator. When the entire antenna structure works, there is no problem of hot point concentration. The hot points are dispersed from each other. This implements a feature of a low SAR, achieves an effect of good performance in an over the air (OTA) test, and avoids a case in which the hot points formed by the antenna radiators are concentrated on one radiator, and consequently radiation power is excessively high and a requirement on a SAR value cannot be met.

In addition, according to the antenna structure provided in this application, the requirement on the low SAR is met by using a structural design of the first radiator and the second radiator in the MF and HF operating bandwidths. An additional technology or component, for example, fixed reduction of power of a hot point, antenna switching (Transmit Antenna Select, TAS), SAR reduction of a receiver, or a capacitive SAR sensor is not required. Therefore, in embodiments of this application, a design of the low SAR at low costs is implemented. In addition, when the feature of the low SAR is implemented, the effect of good performance in the over the air (OTA) test is achieved, and a case in which the hot points formed by the antenna radiators are concentrated on one radiator, and consequently radiation power is excessively high and the requirement on the SAR value cannot be met is avoided.

The following describes in detail the antenna structure provided in embodiments of this application.

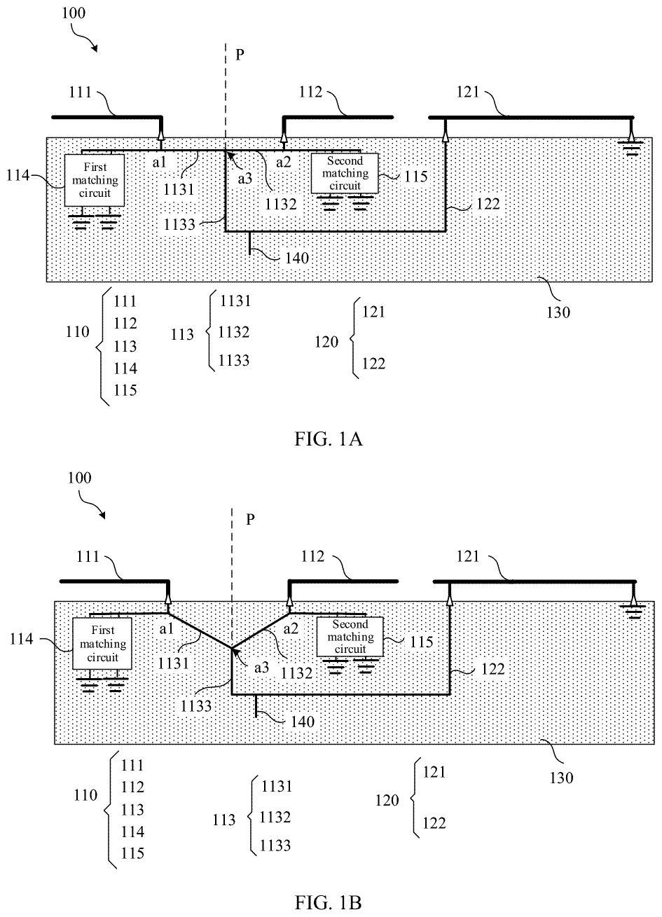

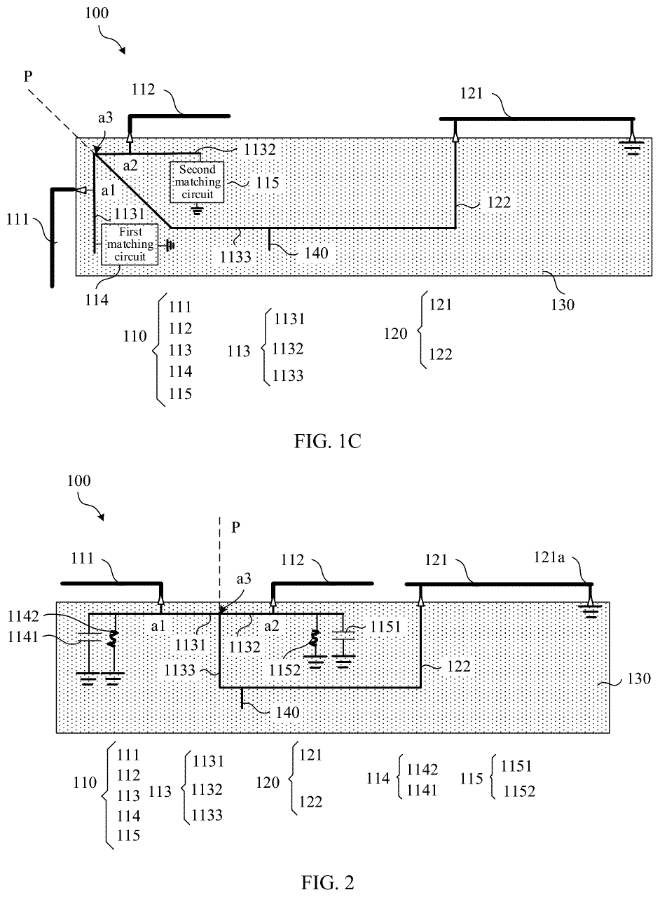

With reference to FIG. 1A, an embodiment of this application provides the antenna structure 100. The antenna structure 100 may include a first antenna 110, a second antenna 120, and a feeding point 140. The feeding point 140 is configured to implement feeding or power input to the first antenna 110 and the second antenna 120. The first antenna 110 and the second antenna 120 share the feeding point 140. For example, the feeding point 140 may simultaneously implement feeding or power input to the first antenna 110 and the second antenna 120.

With reference to FIG. 1A, the first antenna 110 may include a first radiator 111, a second radiator 112, a first transmission line 113, a first matching circuit 114, and a second matching circuit 115. With reference to FIG. 1A, the first transmission line 113 has an intersection point a3, a first connection point a1, and a second connection point a2. The first connection point a1 and the second connection point a2 are respectively located on two sides of the intersection point a3. The intersection point a3 is separately connected to the first connection point a1 and the second connection point a2. The intersection point a3 is electrically connected to the feeding point 140. In this way, after a current or a power input enters from the feeding point 140, the current or the power input is divided into two branches at the intersection point a3. One branch flows to a transmission line on which the first connection point a1 is located (for example, a part that is on the first transmission line 113 and is between the intersection point a3 and the first connection point a1), and the other branch flows to a transmission line on which the second connection point a2 is located (for example, a part that is on the first transmission line 113 and is between the intersection point a3 and the first connection point a1).

With reference to FIG. 1A, one end of the first radiator 111 is electrically connected to the first connection point a1. One end of the second radiator 112 is electrically connected to the second connection point a2. The other end of the first radiator 111 and the other end of the second radiator 112 are separately disposed in an extension manner in directions that are away from each other. For example, as shown in FIG. 1A, the other end of the first radiator 111 and the other end of the second radiator 112 may be separately disposed away from each other in opposite directions. Alternatively, as shown in FIG. 1C, the other end of the first radiator 111 and the other end of the second radiator 112 are separately disposed away from each other in directions perpendicular to each other. Certainly, in some examples, the other end of the first radiator 111 and the other end of the second radiator 112 may alternatively be disposed away from each other in another direction.

It may be understood that the first connection point a1 and the second connection point a2 are not two points fastened onto the first transmission line 113. The first connection point a1 is a point at which the end of the first radiator 111 is electrically connected to and intersects with the first transmission line 113. The second connection point a2 is a point at which the end of the second radiator 112 is electrically connected to and intersects with the first transmission line 113. Therefore, the first connection point a1 and the second connection point a2 change with locations of connections of the first radiator 111 and the second radiator 112 to the first transmission line 113.

With reference to FIG. 1A, the first radiator 111 and the second radiator 112 are disposed away from each other. The first radiator 111 and the second radiator 112 are symmetric relative to a perpendicular bisector P between the first connection point a1 and the second connection point a2. This ensures that the first radiator 111 and the second radiator 112 are two radiators with a same structure.

With reference to FIG. 1A, the intersection point a3 is located on the perpendicular bisector P. In this way, the first radiator 111 and the second radiator 112 are symmetric relative to the feeding center (namely, a3) of the first transmission line 113, to ensure that two transmission paths separated from the intersection point a3 to the first radiator 111 and the second radiator 112 are the same, so as to ensure that transmission paths from the feeding point 140 to the first radiator 111 and the second radiator 112 are the same. In this way, there is no case in which radiation performance of the first radiator 111 and the second radiator 112 is affected because impedance between the first radiator 111 of the first antenna 110 and the feeding point 140 and impedance between the second radiator 112 of the first antenna 110 and the feeding point 140 are different.

In this embodiment of this application, when the current is fed into the feeding point 140, the current is shunted at the intersection point a3 (namely, the feeding center) of the first transmission line 113. Because the first radiator 111 and the second radiator 112 are symmetrically disposed, currents fed into the first radiator 111 and the second radiator 112 are the same. Because the first radiator 111 and the second radiator 112 are disposed in the directions that are away from each other, the currents respectively form two dispersed hot points on the first radiator 111 and the second radiator 112. As a result, when the first antenna 110 works, an effect of hot point dispersion is implemented, to avoid a case in which the hot points are concentrated on one radiator, and consequently radiation power is excessively high and a requirement on a SAR value cannot be met.

With reference to FIG. 1A, to enable the first antenna 110 to support simultaneous working in a medium and high frequency band, in this embodiment of this application, one end of the first matching circuit 114 is electrically connected to the first transmission line 113 located on a side on which the first connection point a1 is located, and the other end of the first matching circuit 114 is grounded. One end of the second matching circuit 115 is electrically connected to the first transmission line 113 located on a side on which the second connection point a2 is located, and the other end of the second matching circuit 115 is grounded.

For example, as shown in FIG. 1A, the first matching circuit 114 and the second matching circuit 115 are respectively located at two tail ends of the first transmission line 113 (for example, one tail end is an end whose extension direction is consistent with an extension direction of the first radiator 111, and the other tail end is an end whose extension direction is consistent with an extension direction of the second radiator). In this way, the first matching circuit 114 and the second matching circuit 115 cooperate with the first radiator 111 and the second radiator 112, so that the first radiator 111 and the second radiator 112 can stimulate resonances in the medium and high frequency band, and the first antenna 110 can support the medium and high frequency band.

To implement that the antenna structure 100 supports simultaneous working at a medium frequency, a high frequency, and a low frequency and implement a small SAR value, with reference to FIG. 1A, the second antenna 120 includes a third radiator 121 and a second transmission line 122. One end of the second transmission line 122 is electrically connected to the feeding point 140. The other end of the second transmission line 122 is electrically connected to one end of the third radiator 121. The other end of the third radiator 121 is grounded. A current is fed into the third radiator 121 of the second antenna 120 through the second transmission line 122, and the first transmission line 113 and the second transmission line 122 are combined to implement feeding or power input through the feeding point 140. Therefore, in this embodiment of this application, the third radiator 121, the first radiator 111, and the second radiator 112 share one feeding point 140 and are independent of each other. In this way, when the current is fed from the feeding point 140, after the current is fed into the third radiator 121 through the second transmission line 122, another hot point is formed on the third radiator 121, and hot points on the three radiators are dispersed from each other. This avoids a problem that the hot points are concentrated on one radiator when the radiators are coupled to each other, and that the SAR value exceeds a standard value due to excessive radiation power at a specific location of the radiator. In addition, an effect of good performance in an over the air (OTA) test is achieved.

In addition, in this embodiment of this application, the first antenna 110 can support radiation in the medium and high frequency band. Therefore, when the third radiator 121 is disposed, a length of the third radiator 121 can be set to be greater than a length of the first radiator 111 or the second radiator 112, so that the second antenna 120 can work in a low frequency band. In this way, the antenna structure 100 provided in this embodiment of this application can support simultaneous working in all medium, high, and low frequency bands, and the hot points formed by the three radiators are dispersed. As a result, a purpose of reducing the SAR value is achieved, and the antenna structure 100 can meet the requirement on the SAR value.

Therefore, according to the antenna structure 100 provided in this embodiment of this application, a requirement on a low SAR is met by using a structural design of the first radiator 111 and the second radiator 112 in MF and HF operating bandwidths. An additional technology or component, for example, fixed reduction of power of a hot point, antenna switching (Transmit Antenna Select, TAS), SAR reduction of a receiver, or a capacitive SAR sensor is not required. Therefore, in this embodiment of this application, a design of the low SAR at low costs is implemented. In addition, when a feature of the low SAR is implemented, an effect of good performance in the over the air (OTA) test is achieved, and a case in which the hot points formed by the antenna radiators are concentrated on one radiator, and consequently the radiation power is excessively high and the requirement on the SAR value cannot be met is avoided.

It should be noted that the hot point mentioned above is specifically a location at which currents converge most intensively on the radiator, and radiation power at the location is high. In addition, that the antenna structure 100 can supports simultaneous working at the medium frequency, the high frequency, and the low frequency may be understood as follows: When a radio frequency module (for example, a feed) feeds a current to the feeding point 140, the current is a signal current that includes all the frequency bands, and the signal current with all the frequency bands generates a medium and high frequency resonance on the first antenna 110, and generates a low frequency resonance on the second antenna 120. In this way, the antenna structure 100 can cover bandwidths of all the medium, high, and low frequency bands, and the current is fed from the shared feeding point 140. Therefore, the antenna structure 100 can ensure simultaneous working at the medium frequency, the high frequency, and the low frequency.

In this embodiment of this application, the feeding point 140 is specifically a connection point at which the first transmission line 113 and the second transmission line 122 are connected to a feeder of the radio frequency module.

In this embodiment of this application, the first transmission line 113 may be electrically connected to the first radiator 111 and the second radiator 112 by using a spring or in a welding manner. The third radiator 121 may also be electrically connected to the second transmission line 122 by using a spring or in the welding manner. When the other end of the third radiator 121 is grounded, the third radiator 121 may also be electrically connected to a grounding point by using a spring.

The first transmission line 113 and the second transmission line 122 may be conductor transmission lines, coaxial transmission lines, waveguides, microstrips, or the like. In this embodiment of this application, an example in which the first transmission line 113 and the second transmission line 122 are microstrips is specifically used for description.

It should be noted that, in this embodiment of this application, the “end” in the end/the other end of the third radiator 121, the end/the other end of the first radiator 111, and the end/the other end of the second radiator 112 cannot be necessarily understood as a point in a narrow sense, and may be alternatively considered as a section of a radiator that includes an endpoint and that is of an antenna radiator. For example, one end of each radiator may be a section of radiator in a range of ⅛ of a wavelength from an endpoint of the end. A wavelength in the ⅛ of the wavelength may be a wavelength corresponding to an operating frequency band of the antenna structure 100, or may be a wavelength corresponding to a center frequency in an operating frequency band, or a wavelength corresponding to a resonance point.

Therefore, in this embodiment of this application, when the other end of the third radiator 121 is grounded, as shown in FIG. 2, grounding may be implemented at an endpoint 121a of the other end of the third radiator 121, or grounding may be implemented at a location that is at a specific distance from the endpoint 121a of the third radiator 121.

In this embodiment of this application, when the other end of the third radiator 121 is grounded, one grounding location may be set, or two grounding locations may be set. In FIG. 1A, an example in which one grounding location is set on the third radiator 121 is specifically used for description. In the following FIG. 4, an example in which two grounding locations are set on the third radiator 121 is used for description.

In this embodiment of this application, when an operating frequency band of the first antenna 110 is the medium and high frequency band, the medium and high frequency band may range from 1710 MHz to 2690 MHz, and when an operating frequency band of the second antenna 120 is the low frequency band, the low frequency band may range from 698 MHz to 960 MHz. Therefore, according to the antenna structure 100 provided in this application, the antenna structure 100 supports simultaneous working at the low frequency, the medium frequency, and the high frequency, and meets the requirement for the small SAR value, and resolves a problem that the antennas cannot work simultaneously at the low frequency, the medium frequency, and the high frequency when a SAR is low.

In a possible implementation, with reference to FIG. 1A, the first connection point a1, the second connection point a2, and the intersection point a3 are located on a same straight line. The intersection point a3 is a midpoint of a connection line between the first connection point a1 and the second connection point a2. In this way, a distance between the first connection point a1 and the intersection point a3 is the same as a distance between the second connection point a2 and the intersection point a3.

In another implementation, as shown in FIG. 1B, the first connection point a1, the second connection point a2, and the intersection point a3 are not on a same straight line. For example, an included angle between a connection line between the first connection point a1 and the intersection point a3 and a connection line between the second connection point a2 and the intersection point a3 exists on the first transmission line 113. The included angle may be larger than 0° and less than 180°.For example, the included angle may be 90° as shown in FIG. 1C. Certainly, the included angle includes but is not limited to 90°, and may alternatively be 60°.

In a possible implementation, the first radiator 111 and the second radiator 112 may be located on a same side, as shown in FIG. 1A and FIG. 1B, or may be located on different sides, as shown in FIG. 1C. In this way, two hot points formed by the first radiator 111 and the second radiator 112 are located on different sides, to further achieve a purpose of hot point dispersion.

In a possible implementation, as shown in FIG. 2, the second matching circuit 115 is the same as the first matching circuit 114, and the second matching circuit 115 and the first matching circuit 114 are symmetrically disposed relative to the perpendicular bisector P. This ensures that grounding locations of the second matching circuit 115 and the first matching circuit 114 are symmetric, and the first radiator 111 and the second radiator 112 can simultaneously stimulate medium and high frequency resonances, to ensure that the second antenna 110 can support simultaneous working at the medium and high frequencies.

Certainly, in some examples, if the second matching circuit 115 and the first matching circuit 114 are not symmetrically disposed relative to the perpendicular bisector P, a tuning component may alternatively be disposed on a link between the first radiator 111 and the second radiator 112, to ensure that the first radiator 111 and the second radiator 112 can simultaneously stimulate medium and high frequency resonances. In this embodiment of this application, an example in which the second matching circuit 115 and the first matching circuit 114 are symmetrically disposed relative to the perpendicular bisector P is used for description.

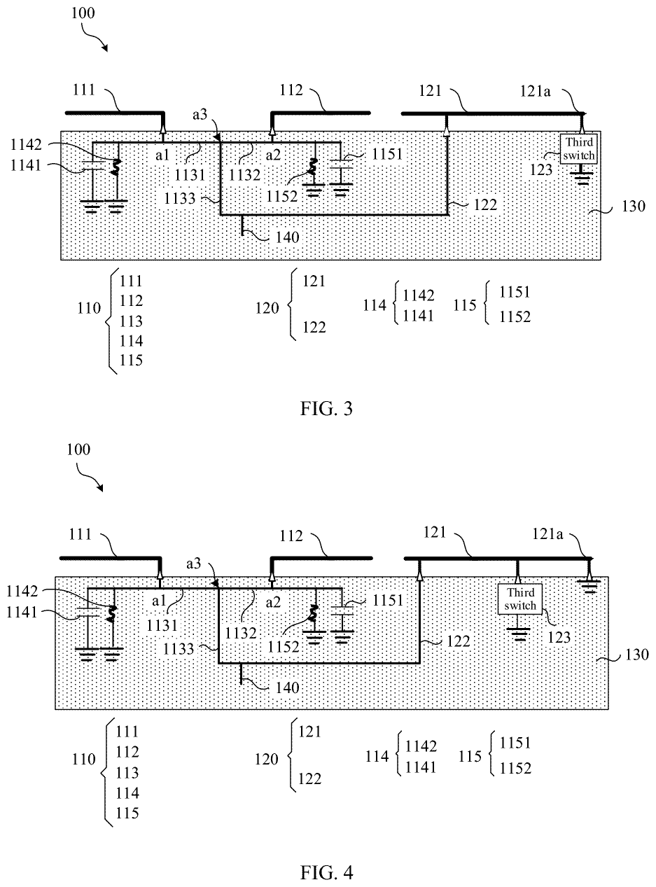

In a possible implementation, the first matching circuit 114 and the second matching circuit 115 may be resonant (LC) circuits. For example, with reference to FIG. 3, the first matching circuit 114 includes a first capacitor 1141 and a first inductor 1142. The first capacitor 1141 and the first inductor 1142 are disposed in parallel. One end of the first capacitor 1141 and one end of the first inductor 1142 are both electrically connected to the first transmission line 113 on the side on which the first connection point a1 is located. The other end of the first capacitor 1141 and the other end of the first inductor 1142 are both grounded.

With reference to FIG. 3, the second matching circuit 115 includes a second capacitor 1151 and a second inductor 1152. The second capacitor 1151 and the second inductor 1152 are disposed in parallel. One end of the second capacitor 1151 and one end of the second inductor 1152 are both electrically connected to the first transmission line 113 on the side on which the second connection point a2 is located. The other end of the second capacitor 1151 and the other end of the second inductor 1152 are both grounded.

When the first antenna 110 works, a medium frequency current may pass through the first inductor 1142 and the second inductor 1152, and the first capacitor 1141 and the second capacitor 1151 block the medium frequency current. In this way, the medium frequency current is grounded through the first inductor 1142 and the second inductor 1152, and cannot be grounded through the first capacitor 1141 and the second capacitor 1151. As a result, the first radiator 111 and the second radiator 112 can stimulate resonances in the medium frequency band. This ensures that the first radiator 111 and the second radiator 112 can support the medium frequency band. When a high frequency current flows in, the high frequency current may pass through the first capacitor 1141 and the second capacitor 1151, and the first inductor 1142 and the second inductor 1152 block the high frequency current. In this way, the high frequency current is grounded through the first capacitor 1141 and the second capacitor 1151, and the first radiator 111 and the second radiator 112 may stimulate resonances in the high frequency band. Therefore, the medium frequency passes through the first inductor 1142 and the second inductor 1152, the first inductor 1142 and the second inductor 1152 block the high frequency, the high frequency passes through the first capacitor 1141 and the second capacitor 1151, and the first capacitor 1141 and the second capacitor 1151 block the medium frequency. This ensures that the first antenna 110 can support the medium frequency band and the high frequency band simultaneously. Therefore, in this embodiment of this application, the first capacitor 1141 and the first inductor 1142 are disposed in parallel, and the second capacitor 1151 and the second inductor 1152 are disposed in parallel, so that the two radiators of the first antenna 110 can support simultaneous working at the medium frequency and the high frequency.

In this embodiment of this application, capacitance values of the first capacitor 1141 and the second capacitor 1151 may be the same, and inductance values of the first inductor 1142 and the second inductor 1152 may be the same.

Certainly, in some examples, capacitance values of the first capacitor 1141 and the second capacitor 1151 may alternatively be different. When the capacitance values of the first capacitor 1141 and the second capacitor 1151 are different, a tuning component may be added to a link of the first radiator 111, or a tuning component may be added to the link of the first radiator 111. Correspondingly, when the inductance values of the first inductor 1142 and the second inductor 1152 are different, a tuning component may also be added to the link of the first radiator 111, or a tuning component may be added to the link of the first radiator 111.

In this embodiment of this application, with reference to FIG. 2, the first capacitor 1141 and the second capacitor 1151 are symmetrically disposed relative to the perpendicular bisector P, and the first inductor 1142 and the second inductor 1152 are symmetrically disposed relative to the perpendicular bisector P. In this way, a distance between the first inductor 1142 and the feeding center of the first transmission line 113 is the same as a distance between the second inductor 1152 and the feeding center of the first transmission line 113. As a result, grounding locations of the first inductor 1142 and the second inductor 1152 are symmetric relative to the feeding center of the first transmission line 113. Consequently, the first inductor 1142 and the second inductor 1152 separately have same impact on the first radiator 111 and the second radiator 112. Correspondingly, the distance between the first inductor 1142 and the feeding center of the first transmission line 113 is the same as the distance between the second inductor 1152 and the feeding center of the first transmission line 113. As a result, grounding locations of the first capacitor 1141 and the second capacitor 1151 are symmetric relative to the feeding center of the first transmission line 113. Consequently, the first capacitor 1141 and the second capacitor 1151 separately have same impact on the first radiator 111 and the second radiator 112. This avoids a problem that the medium frequency band and the high frequency band cannot be supported because impedance of the two radiators is different due to different grounding locations.

In a possible implementation, with reference to FIG. 3, the second antenna 120 further includes a third switch 123. The other end of the third radiator 121 is grounded through the third switch 123. For example, with reference to FIG. 3, the other end of the third radiator 121 is electrically connected to the third switch 123, and the other end of the third switch 123 is grounded. When the third radiator 121 is grounded through the third switch 123, the third switch 123 may perform a tuning function, so that a resonance point of the third radiator 121 can be adjusted.

In another implementation, with reference to FIG. 4, the other end (for example, the endpoint 121a) of the third radiator 121 is grounded. The end of the third switch 123 is electrically connected to the third radiator 121, and the other end of the third switch 123 is also grounded. The third radiator 121 has two grounding locations. During working, different grounding points may be selected based on different requirements. For example, in a scenario, the third switch 123 may be disconnected, and the third radiator 121 is grounded at the endpoint 121a, so that the third radiator 121 can meet a requirement of one of the low frequency bandwidths. In another scenario, the third switch 123 may be switched to a frequency band and connected, so that the third radiator 121 may be grounded through the third switch 123. Because the ground points are different, a resonance point of the third radiator 121 changes. Therefore, in this embodiment of this application, another third switch 123 is further disposed when the third radiator 121 is grounded. In one aspect, a tuning function is performed. In another aspect, different grounding locations can be selected for different working scenarios.

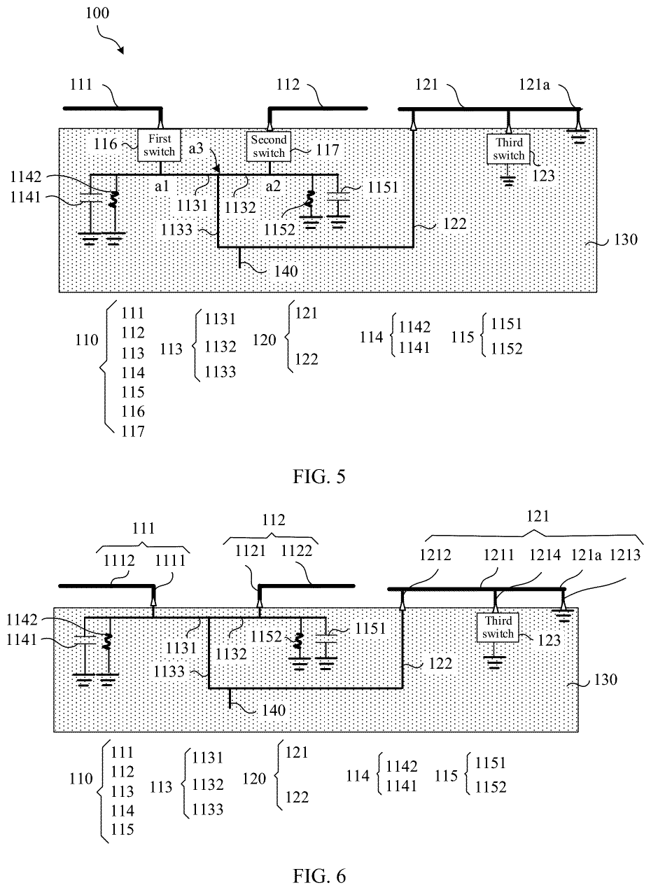

In a possible implementation, with reference to FIG. 5, the first antenna 110 may further include a first switch 116. The first switch 116 is located on a connection link between the first radiator 111 and the first connection point a1. For example, as shown in FIG. 5, one end of the first switch 116 is connected to the first connection point a1 of the first transmission line 113, and the other end of the first switch 116 may be electrically connected to the first radiator 111 by using a spring. The first switch 116 may perform a tuning function. For example, the first switch 116 may adjust resonance points at the medium frequency and the high frequency.

With reference to FIG. 5, the first antenna 110 may further include a second switch 117. The second switch 117 is located on a connection link between the second radiator 112 and the second connection point a2. For example, as shown in FIG. 5, one end of the second switch 117 is connected to the second connection point a2 of the first transmission line 113, and the other end of the second switch 117 may be electrically connected to the second radiator 112 by using a spring. The second switch 117 may perform a tuning function. In this way, the first switch 116 and the second switch 117 can jointly adjust the resonance points of at medium frequency and the high frequency.

In a possible implementation, as shown in FIG. 6, the antenna structure further includes a circuit board 130. The first transmission line 113, the second transmission line 122, the first matching circuit 114, the second matching circuit 115, and the feeding point 140 are all located on the circuit board 130. The first radiator 111, the second radiator 112, and the third radiator 121 are located on an outer side of an edge of the circuit board 130. For example, with reference to FIG. 6, the first radiator 111, the second radiator 112, and the third radiator 121 are located on the outer side of the edge of the circuit board 130. This ensures that the first radiator 111, the second radiator 112, and the third radiator 121 radiate electromagnetic waves outward in free space, without being likely to be affected by the circuit board 130.

Certainly, in some examples, the first radiator 111, the second radiator 112, and the third radiator 121 may be suspended above the circuit board 130. For example, orthographic projections of the first radiator 111, the second radiator 112, and the third radiator 121 in a thickness direction of the circuit board 130 are located on the circuit board 130.

In a possible implementation, with reference to FIG. 6, the first radiator 111, the second radiator 112, and the third radiator 121 are located on a same side of an outer edge of the circuit board 130. For example, in FIG. 6, the first radiator 111, the second radiator 112, and the third radiator 121 are located on a side of an upper edge of the circuit board 130, and the second radiator 112 is located between the first radiator 111 and the third radiator 121. With reference to FIG. 6, the first antenna 110 is located at the left end of the side of the upper edge of the circuit board 130, and the second antenna 120 is located at the right end of the upper edge of the circuit board 130.

Certainly, in some examples, the first radiator 111, the second radiator 112, and the third radiator 121 may be separately located on different sides of an outer edge of the circuit board 130. For example, the first radiator 111 and the second radiator 112 may be located on one side of an upper edge of the circuit board 130, and the third radiator 121 may be located on one side of the right edge of the circuit board 130. Alternatively, the first radiator 111 and the second radiator 112 are separately located on two adjacent sides of the circuit board 130. For example, the first radiator 111 is located on the left side of the circuit board 130, the second radiator 112 is located on the upper side of the circuit board 130 (with reference to FIG. 1C), and the second radiator 112 and the third radiator 121 are located on a same side.

Therefore, in this embodiment of this application, locations at which the first radiator 111, the second radiator 112, and the third radiator 121 are disposed on an edge of the circuit board 130 have no impact on performance of the antenna structure 100. This ensures that the first radiator 111, the second radiator 112, and the third radiator 121 are disposed at flexible locations on the edge of the circuit board 130, and there is no limitation on the locations at which the radiators are disposed.

In this way, when the antenna structure 100 is used in an electronic device, locations of the first radiator 111, the second radiator 112, and the third radiator 121 can be flexibly arranged, so that a component layout in the electronic device is not limited to a fixed location. This ensures a flexible component layout of the electronic device.

In a possible implementation, with reference to FIG. 6, the first transmission line 113 includes a first branch transmission section 1131 and a second branch transmission section 1132. The first connection point a1 is located on the first branch transmission section 1131. The second connection point a2 is located on the second branch transmission section 1132. One end of the first branch transmission section 1131 and one end of the second branch transmission section 1132 are both electrically connected to the intersection point a3. The first branch transmission section 1131 and the second branch transmission section 1132 are respectively located on two sides of the intersection point a3. The other end of the first branch transmission section 1131 and the other end of the second branch transmission section 1132 are respectively electrically connected to the first matching circuit 114 and the second matching circuit 115.

It may be understood that the intersection point a3 is a point at which a section of the first branch transmission section 1131 intersects with a section of the second branch transmission section 1132.

In a possible implementation, with reference to FIG. 6, the first transmission line 113 further includes a general transmission section 1133. One end of the general transmission section 1133 is electrically connected to the feeding point 140. The other end of the general transmission section 1133 is electrically connected to the intersection point a3. A point at which the other end of the general transmission section 1133, the end of the first branch transmission section 1131, and the end of the second branch transmission section 1132 intersect forms the intersection point.

With reference to FIG. 6, the general transmission section 1133 is combined with the second transmission line 122 and then is connected to the feeding point 140.

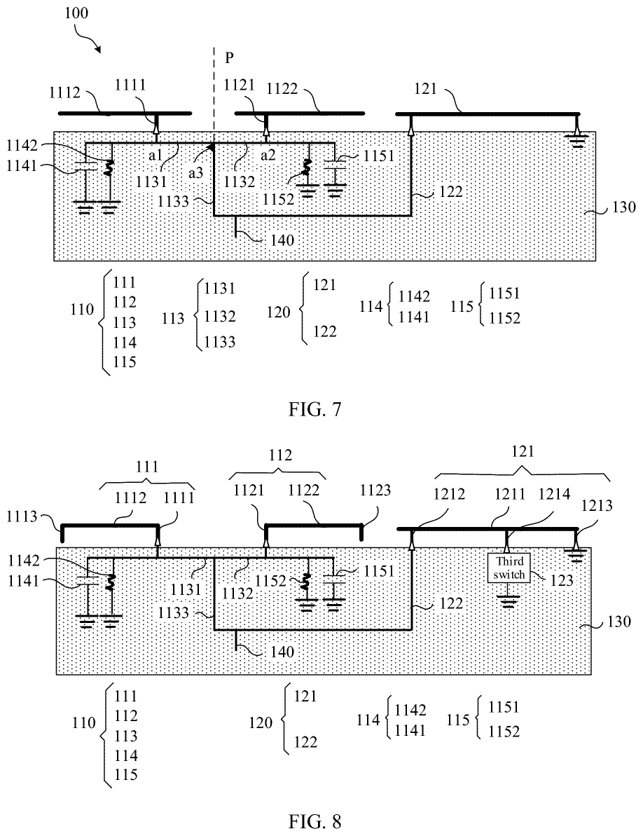

In a possible implementation, as shown in FIG. 6, the first radiator 111 includes a first vertical stub 1111 and a first horizontal stub 1112. One end of the first vertical stub 1111 is electrically connected to the first horizontal stub 1112. The second radiator 112 also includes a first vertical stub 1121 and a first horizontal stub 1122. One end of the first vertical stub 1121 is electrically connected to the first horizontal stub 1122. For example, with reference to FIG. 7, the first horizontal stub 1112 of the first radiator 111 is disposed leftward in the extension manner, and the first horizontal stub 1122 of the second radiator 112 is disposed rightward in the extension manner.

In a possible implementation, with reference to FIG. 8, the first radiator 111 further includes a second vertical stub 1113. One end of the second vertical stub 1113 is electrically connected to the first horizontal stub 1112. For example, one end of the second vertical stub 1113 is electrically connected to an endpoint of one end of the first horizontal stub 1112, and the other end of the second vertical stub 1113 faces the first transmission line 113. The second radiator 112 further includes a second vertical stub 1123. One end of the second vertical stub 1123 is electrically connected to the first horizontal stub 1122, and the other end of the second vertical stub 1123 faces the first transmission line 113. The second vertical stubs 1113 (1123) are added to increase a bandwidth.

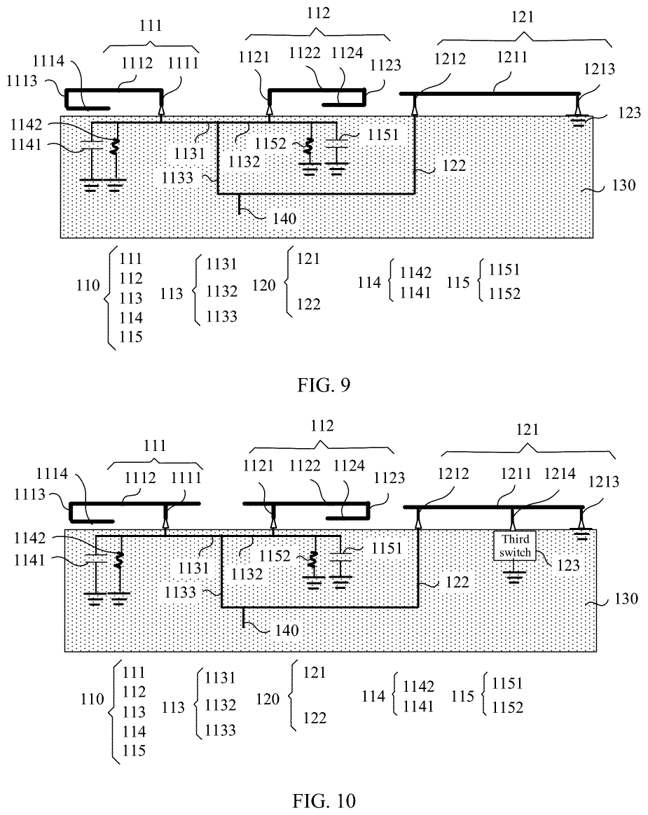

In a possible implementation, with reference to FIG. 9, the first radiator 111 further includes a second horizontal stub 1114. One end of the second horizontal stub 1114 is electrically connected to the other end of the second vertical stub 1113. The other end of the second horizontal stub 1114 faces the first vertical stub 1111, and there is an interval between the other end of the second horizontal stub 1114 and the first vertical stub 1111. Correspondingly, the second radiator 112 further includes a second horizontal stub 1124. One end of the second horizontal stub 1124 is electrically connected to the other end of the second vertical stub 1123. The other end of the second horizontal stub 1124 faces the first vertical stub 1121, and there is an interval between the other end of the second horizontal stub 1124 and the first vertical stub 1121.

In a possible implementation, with reference to FIG. 9, the third radiator 121 includes a third horizontal stub 1211, a third vertical stub 1212, and a fourth vertical stub 1213. One end of the third vertical stub 1212 and one end of the fourth vertical stub 1213 are electrically connected to the third horizontal stub 1211. The other end of the third vertical stub 1212 is electrically connected to the second transmission line 122. The other end of the fourth vertical stub 1213 is grounded. In this way, the second antenna 120 can form an F antenna.

In this embodiment of this application, when the first vertical stub 1111 is connected to the first horizontal stub 1112, one end of the first vertical stub 1111 may be connected to the endpoint of the end of the first horizontal stub 1112, as shown in FIG. 9, or may be electrically connected to a part between two endpoints of the first horizontal stub 1112, as shown in FIG. 10. There is an interval between the first horizontal stub 1112 of the first radiator 111 and the first horizontal stub 1112 of the second radiator 112. A size of the interval may be set based on an actual requirement. For example, the interval may ensure that no current coupling occurs between the first horizontal stub 1112 of the first radiator 111 and the first horizontal stub 1112 of the second radiator 112. With reference to FIG. 10, the third radiator 121 further includes a fifth vertical stub 1214. The fifth vertical stub 1214 is located between the third vertical stub 1212 and the fourth vertical stub 1213. One end of the fifth vertical stub 1214 is electrically connected to the third horizontal stub 1211. The other end of the fifth vertical stub 1214 may be electrically connected to the third switch 123 and grounded.

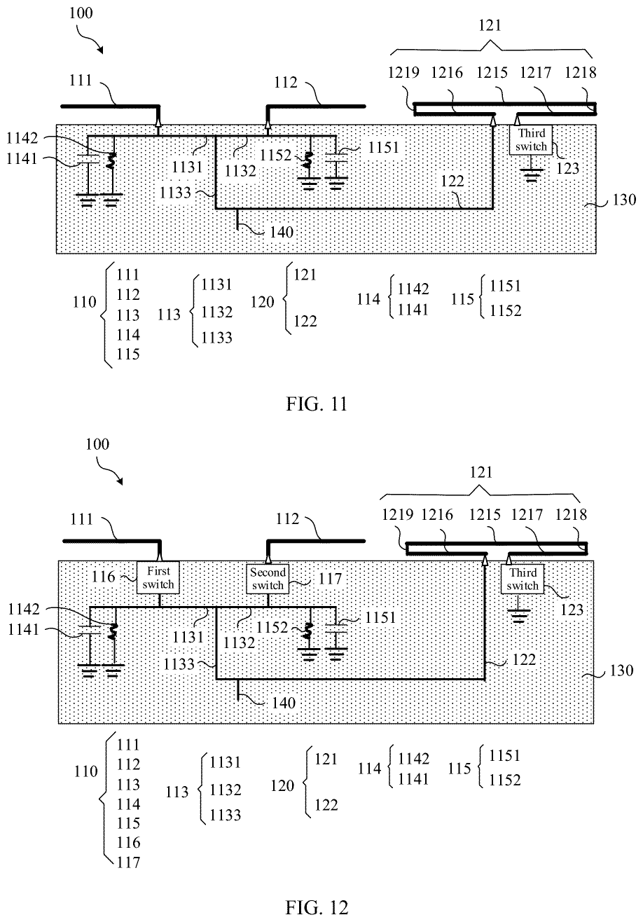

In a possible implementation, with reference to FIG. 11, the third radiator 121 includes a fourth horizontal stub 1215, a fifth horizontal stub 1216, a sixth horizontal stub 1217, a sixth vertical stub 1218, and a seventh vertical stub 1219. Two ends of the fourth horizontal stub 1215 are respectively electrically connected to one end of the sixth vertical stub 1218 and one end of the seventh vertical stub 1219. The other end of the sixth vertical stub 1218 and the other end of the seventh vertical stub 1219 are respectively electrically connected to one end of the fifth horizontal stub 1216 and one end of the sixth horizontal stub 1217. The other end of the fifth horizontal stub 1216 is electrically connected to the second transmission line 122. The other end of the sixth horizontal stub 1217 is grounded. In this way, the second antenna 120 can form a loop antenna.

With reference to FIG. 12, the other end of the sixth horizontal stub 1217 is grounded through the third switch 123. In addition, the first switch 116 and the second switch 117 are separately disposed between the first radiator 111 and the first transmission line 113 and between the second radiator 112 and the first transmission line 113. The first switch 116, the second switch 117, and the third switch 123 are all antenna switches, for example, may be PIN diode switches or single-pole multi-throw switches.

It should be noted that, in this embodiment of this application, shapes of the first radiator 111, the second radiator 112, and the third radiator 121 include but are not limited to shapes shown in FIG. 1A to FIG. 13. In some examples, the shapes of the first radiator 111, the second radiator 112, and the third radiator 121 may alternatively be changed based on an actual requirement.

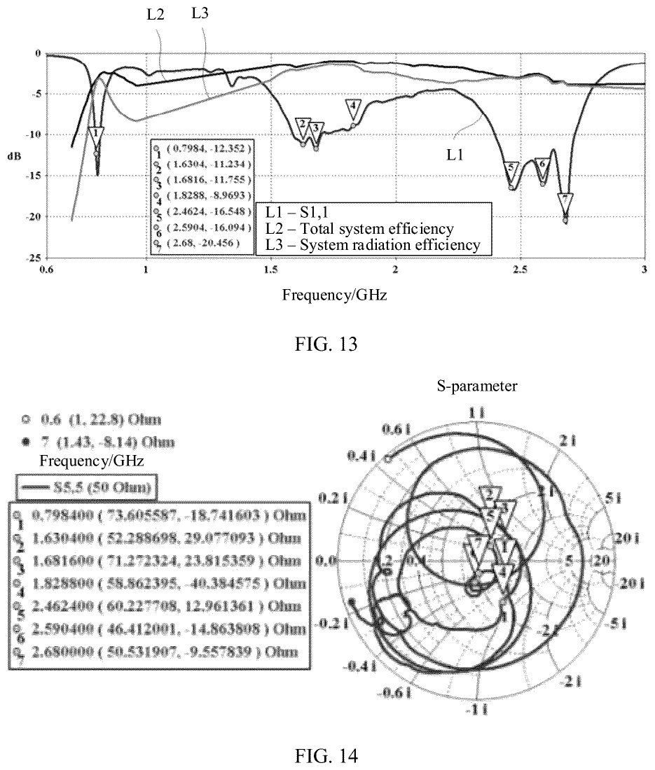

In an embodiment of this application, the antenna structure 100 is tested. For example, the antenna structure 100 provided in FIG. 5 is tested. For example, the second antenna 120 works in long term evolution (LTE) B20. A result obtained through simulation is shown in FIG. 13. With reference to FIG. 13, L1 is an S11 curve (antenna return loss), L2 is system radiation efficiency, and L3 is total system radiation efficiency. It can be learned from the L1 curve that the antenna structure 100 provided in this embodiment of this application has a plurality of pieces of antenna resonances in a frequency band range of 0.6 GHz to 3 GHz. An LF antenna, an MF antenna, and an HF antenna separately have deepest resonance points at 0.7984 GHz, 1.6304 GHz, 1.6816 GHz, 1.828 GHz, 2.4624 GHz, 2.5904 GHz, and 2.68 GHz in an operating bandwidth of-5 dB. Therefore, the antenna structure 100 provided in this embodiment of this application can work normally at the LF, the MF, and the HF.

It should be noted that an S11 parameter is usually a negative number. A smaller S11 parameter indicates a smaller antenna return loss and less energy reflected by an antenna. To be specific, it indicates that more energy that actually enters the antenna indicates higher system efficiency of the antenna. A greater S11 parameter indicates a larger antenna return loss and lower system efficiency of the antenna. In engineering, an S11 value of −6 dB is usually used as a standard.

When the S11 value of the antenna is less than −6 dB, it may be considered that the antenna can work normally or transmit efficiency of the antenna is good. Therefore, the antenna structure 100 provided in this embodiment of this application can support simultaneous working at the LF, the MF, and the HF.

FIG. 14 is a Smith circle diagram of the LF, the MF, and the HF when the second antenna 120 works in B20. With reference to FIG. 14, locations of frequencies in FIG. 13 are close to a central circle in the Smith circle diagram, which indicates that the antenna is well matched and has good performance.

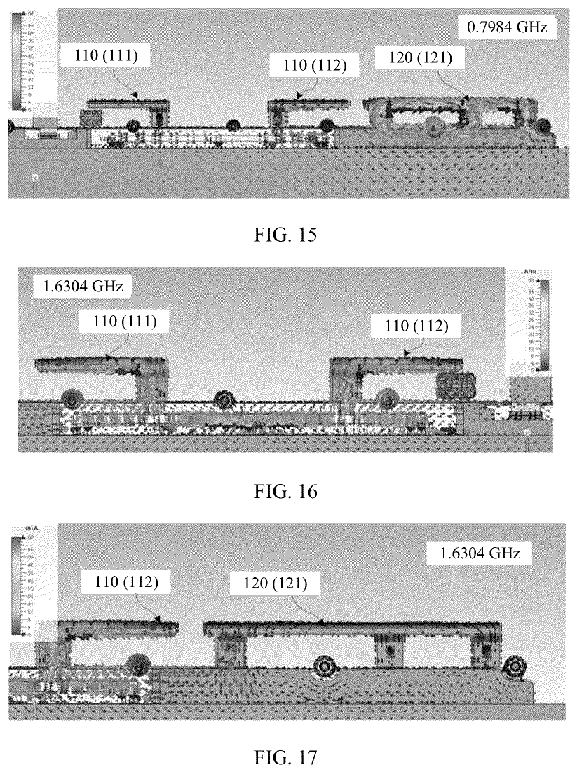

In an embodiment of this application, to determine a working mode of the resonance points, a distribution of currents at the frequencies is monitored. A current distribution obtained when the antenna structure 100 works at 0.7984 GHz is shown in FIG. 15. It can be learned from FIG. 15 that a current is mainly concentrated on the third radiator 121 of the second antenna 120, and currents on the first radiator 111 and the second radiator 112 are basically weak (because a long electric length is required for a low frequency of 0.7984 GHz, but the first radiator 111 and the second radiator 112 do not meet a requirement on an electric length, and the currents cannot form a corresponding mode on the first radiator 111 and the second radiator 112). Therefore, the third radiator 121 of the second antenna 120 supports the low frequency band, and the currents form a typical left-hand antenna working mode on the third radiator 121.

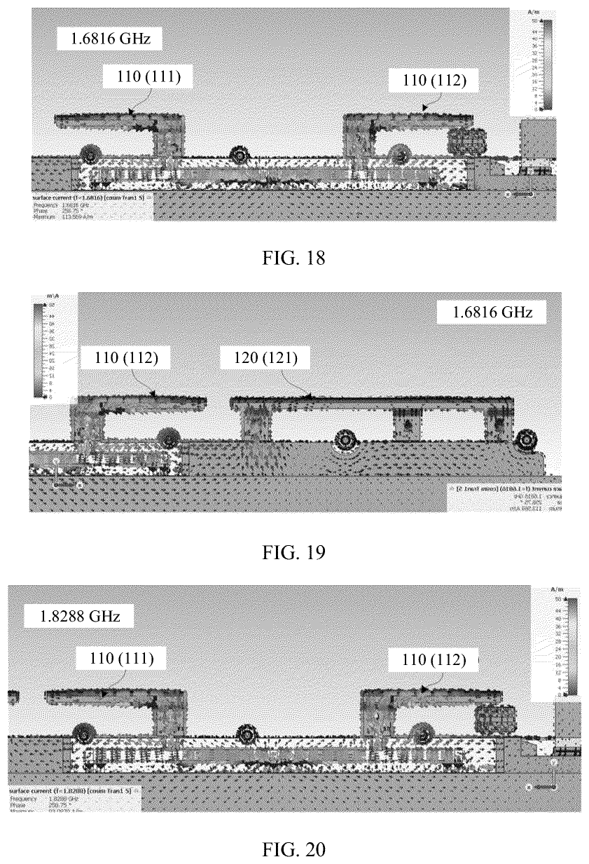

FIG. 16 to FIG. 21 show current distributions in an MF frequency band region in which the antenna structure 100 works at 1.6304 GHz, 1.6816 GHz, and 1.828 GHz. It can be learned that, in the MF frequency band range, a current on the third radiator 121 of the second antenna 120 is basically weak, and current distributions in the MF frequency band range are all concentrated on the first radiator 111 and the second radiator 112 of the first antenna 110. Flow directions of the currents on the first radiator 111 and the second radiator 112 are opposite and symmetric, current distributions on the first transmission line 113 are opposite and symmetric, and the first antenna 110 forms a typical common-mode mode.

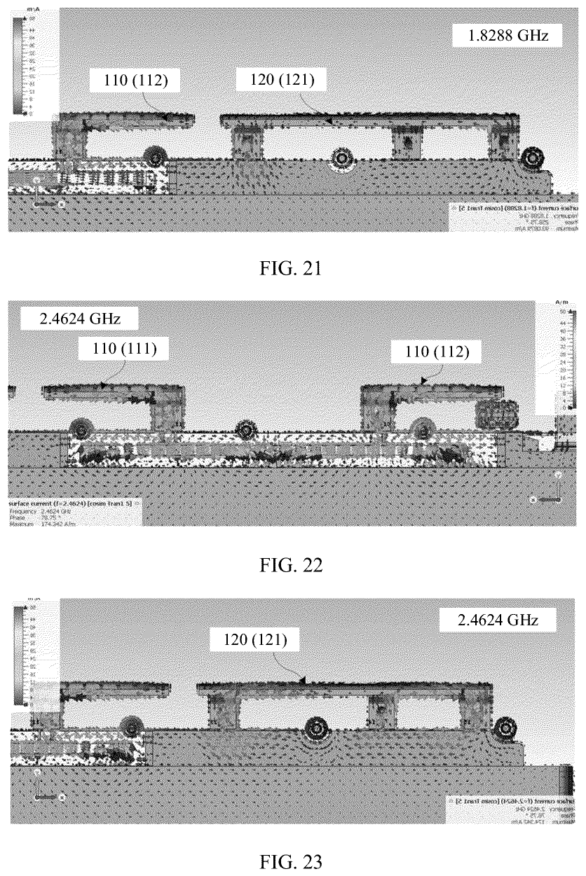

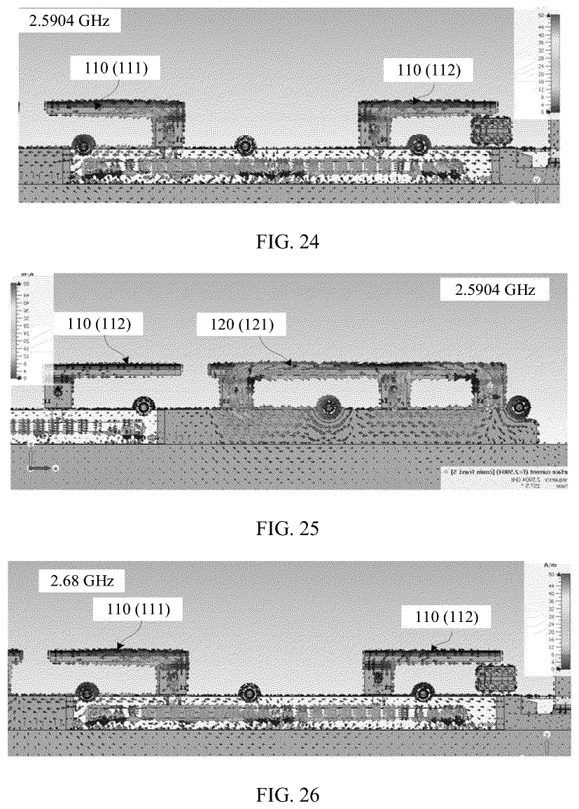

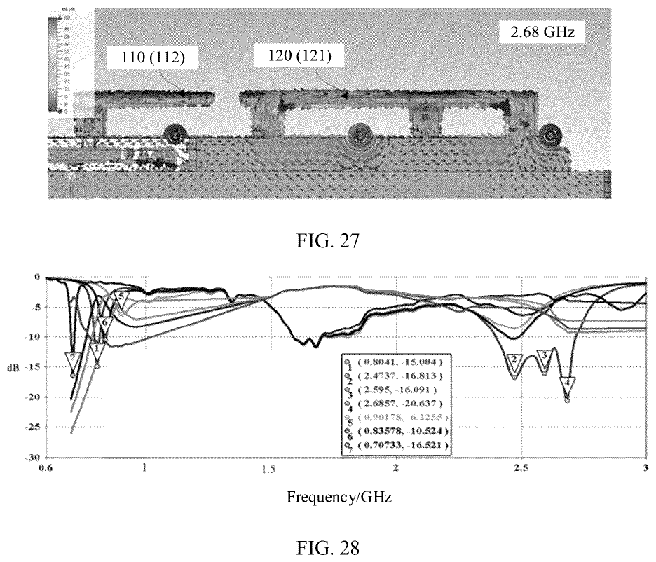

FIG. 22 to FIG. 27 show current distributions in an HF frequency band region in which the antenna structure 100 works at 2.4624 GHz, 2.5904 GHz, and 2.68 GHz. It can be learned from FIG. 22 to FIG. 27 that, in the HF frequency band range, a current on the third radiator 121 of the second antenna 120 is basically equivalent to currents on the first radiator 111 and the second radiator 112 of the first antenna 110. It can be learned from a current distribution on the third radiator 121 of the second antenna 120 that the HF is produced through frequency tripling of the second antenna 120. Flow directions of the currents on the first radiator 111 and the second radiator 112 of the first antenna 110 are opposite and symmetric, and current distributions on the first transmission line 113 are opposite and symmetric. This forms a typical common-mode mode. To be specific, a working mode at the three HF frequencies 2.4624 GHz, 2.5904 GHz, and 2.68 GHz is a hybrid mode formed through superposition of frequency tripling of the second antenna 120 and a common mode of the first antenna

In an embodiment of this application, when the second antenna 120 is switched, through the third switch 123, to work at different low frequencies such as LTE B8/B5/B12/B17/B28, an S11 curve at the LF, the MF, and the HF is shown in FIG. 28. It can be learned from FIG. 28 that a plurality of antenna resonances (for example, seven resonance points in FIG. 28) occur in a frequency band range of 0.6 GHz to 3 GHz. The antenna can work normally at the LF, the MF, and the HF. Each frequency is close to the central circle in the Smith circle diagram, which indicates that the antenna is well matched and has good performance.

According to the antenna structure 100 provided in this embodiment of this application, technical effects of total radiated power that are obtained when SARs in different frequency bands meet a regulatory requirement are shown in Table 1. During a test, when a conducted transmit power is 24.5 dBm and a 5 mm-10 g SAR in frequency bands such as LTE B1/3/7/38/40/41 and WB1/B8 is less than 1 W/kg, the TRP (total radiated power) can be greater than 16.9 dBm at the low frequency and greater than 17.7 dBm at the high frequency. A 3 db requirement on a high OTA performance indicator is met through the feature of the low SAR of the antenna structure 100. Therefore, the antenna structure 100 provided in this embodiment of this application may be used in a terminal product that supports a plurality of LTE frequency bands, for example, a mobile phone, a tablet computer, or a PC. For a product that needs to meet a regulatory requirement on the SAR, low costs, the low SAR, and the high OTA performance indicator can be implemented. This improves actual communication experience of a user when the regulatory requirement is met.

TABLE 1
Attainments of the TRPs (Total Radiated Powers, total
radiated powers) in the different frequency bands obtained
when the SARs meet the regulatory requirement

| | | | | TRP (dBm) |
|---|---|---|---|---|
| | | | | obtained |
| | | Antenna | 5 mm-10 g SAR | when the |
| | Frequency | efficiency | value | SAR value is |
| Standard | band | (dB) | (W/kg) | less than 1 W/kg |
| LTE | B1 | −2.7 | 1.37 | 19.30 |
| | B3 | −2.8 | 1.56 | 18.70 |
| | B7 | −3.8 | 1.53 | 17.70 |
| | B38 | −3.3 | 1.51 | 18.20 |
| | B40 | −3.8 | 1.21 | 18.70 |
| | B41 | −3.6 | 1.56 | 17.90 |
| WCDMA | B1 | −2.7 | 1.37 | 19.30 |
| | B8 | −5.6 | 1.19 | 16.90 |

The following describes another antenna structure 100 provided in an embodiment of this application.

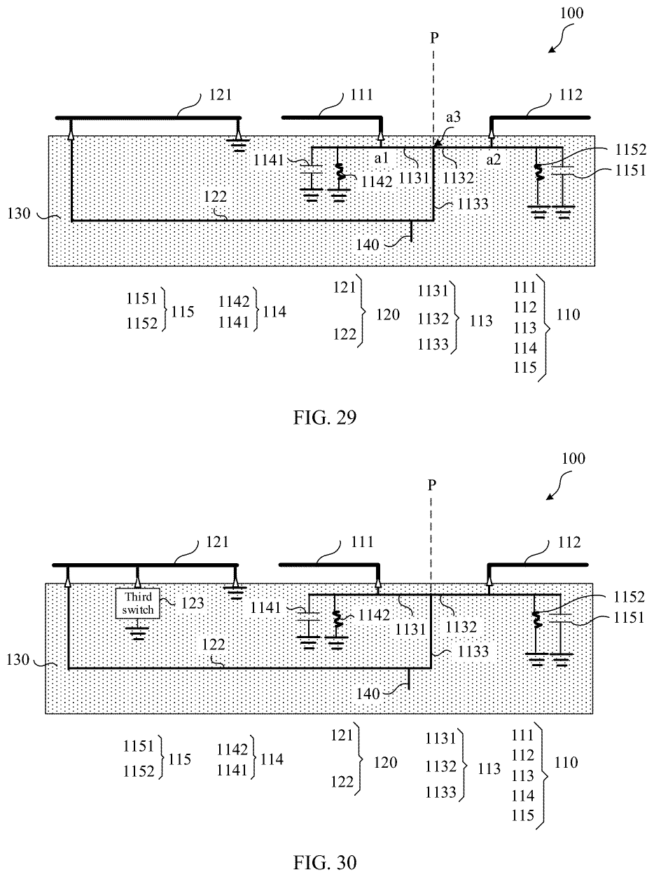

A difference between the antenna structure 100 provided in this embodiment of this application and the antenna structure 100 in the foregoing embodiments is that, in this embodiment of this application, locations of the first antenna 110 and the second antenna 120 are exchanged. With reference to FIG. 29, the first antenna 110 is disposed on the right side of the second antenna 120, and the first radiator 111 is located between the second radiator 112 and the third radiator 121. A location of a grounding point of the third radiator 121 is close to a tail end of the first radiator 111.

With reference to FIG. 30, in this embodiment of this application, one end of the third switch 123 of the second antenna 120 is electrically connected to the middle location of the third radiator 121, and the other end of the third switch 123 is grounded.

For another structure in this embodiment of this application, refer to the descriptions of the foregoing embodiments. Details are not described again in this embodiment of this application.

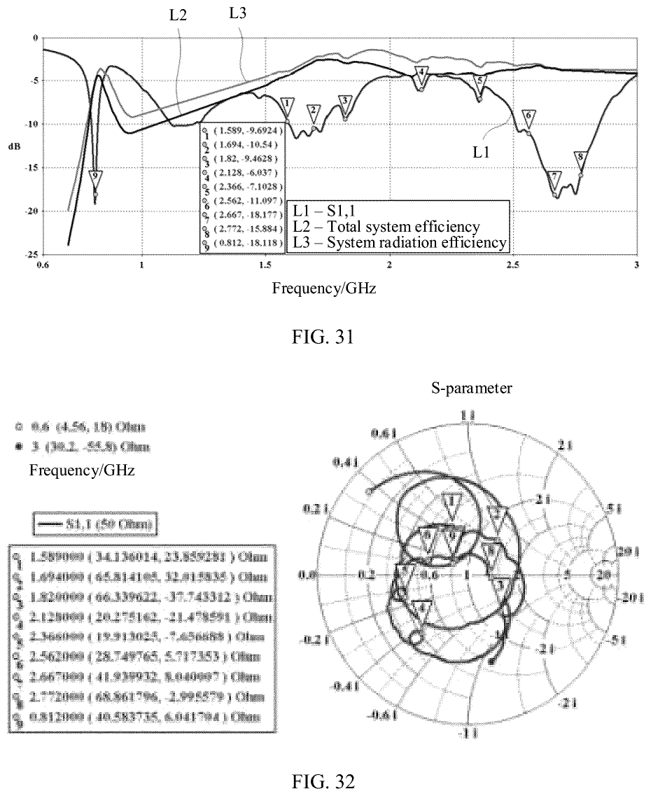

A simulation test is performed on the antenna structure 100 provided in FIG. 30 in this embodiment of this application. For example, the second antenna 120 works in LTE B20. An S11 curve, antenna radiation, and system efficiency that are obtained through simulation at an LF, an MF, and an HF are shown in FIG. 31. A Smith circle diagram at the LF, the ME, and the HF that is obtained when the second antenna 120 works in B20 is shown in FIG. 32. As shown in FIG. 31, an antenna system has a plurality of antenna resonances (for example, nine resonance points in FIG. 31) in a frequency band range of 0.6 to 3 GHz. An LF antenna, an MF antenna, and an HF antenna separately have deepest resonance points at 0.812 GHz, 1.589 GHz, 1.694 GHz, 1.82 GHz, 2.128 GHz, 2.366 GHz, 2.562 GHz, 2.667 GHz, and 2.772 GHz in an operating bandwidth of −5 dB. Compared with that in FIG. 13, when locations of the first antenna 110 and the second antenna 120 are changed, frequency offset of the resonance points occurs. However, a bandwidth requirement can still be met, and working at the low frequency, the medium frequency, and the high frequency can still be implemented. Therefore, when the locations of the first antenna 110 and the second antenna 120 are changed, there is little impact on an operating frequency band of the antenna structure 100. In this way, when the antenna structure 100 is used in an electronic device, locations of the first radiator 111, the second radiator 112, and the third radiator 121 can be flexibly arranged, so that a component layout in the electronic device is not limited to a fixed location. This ensures a flexible component layout of the electronic device.

With reference to FIG. 32, locations of the frequencies are close to a central circle in the Smith circle diagram, which indicates that the antenna is well matched, and antenna performance is good.

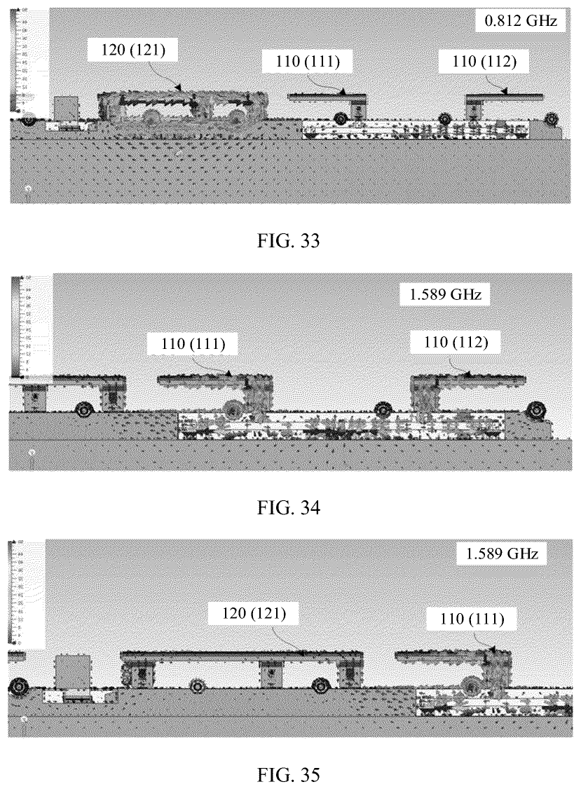

In an embodiment of this application, to determine a working mode of the resonance points, a distribution of currents at the frequencies is monitored. A current distribution obtained when the antenna structure 100 works at 0.812 GHz is shown in FIG. 33. It can be learned from FIG. 33 that a current is mainly concentrated on the third radiator 121 of the second antenna 120, and currents on the first radiator 111 and the second radiator 112 are basically weak (because a long electric length is required for a low frequency of 0.812 GHz, but the first radiator 111 and the second radiator 112 do not meet a requirement on an electric length, and the currents cannot form a corresponding mode on the first radiator 111 and the second radiator 112). Therefore, the third radiator 121 of the second antenna 120 supports a low frequency band, and the currents form a typical left-hand antenna working mode on the third radiator 121.

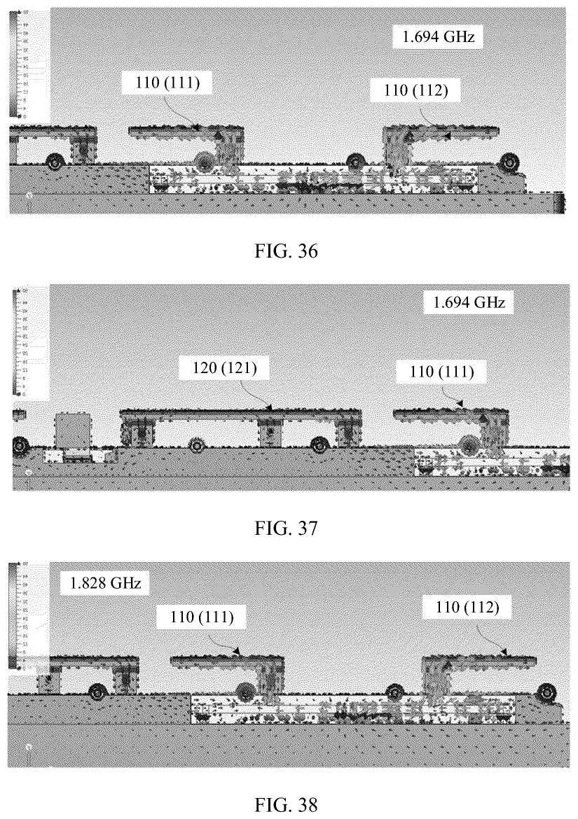

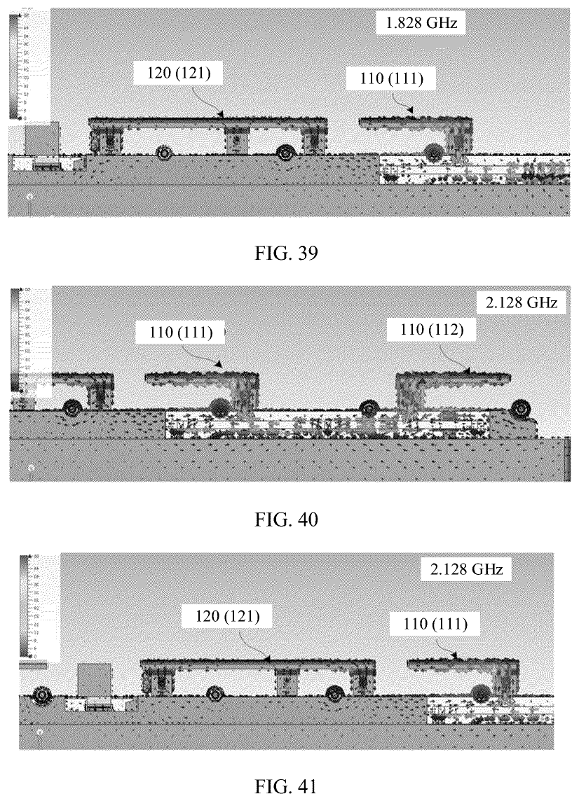

FIG. 34 to FIG. 41 show current distributions in an MF frequency band region in which the antenna structure 100 works at 1.589 GHz (as shown in FIG. 34 and FIG. 35), 1.694 GHz (as shown in FIG. 36 and FIG. 37), 1.82 GHz (as shown in FIG. 38 and FIGS. 39), and 2.128 GHz (as shown in FIG. 40 and FIG. 41). It can be learned from FIG. 34 to FIG. 41 that, in the MF frequency band range, a current on the third radiator 121 of the second antenna 120 is basically weak, and current distributions in the MF frequency band range are all concentrated on the first radiator 111 and the second radiator 112 of the first antenna 110. Flow directions of the currents on the first radiator 111 and the second radiator 112 are opposite and symmetric, current distributions on the first transmission line 113 are opposite and symmetric, and the first antenna 110 forms a typical common-mode mode.

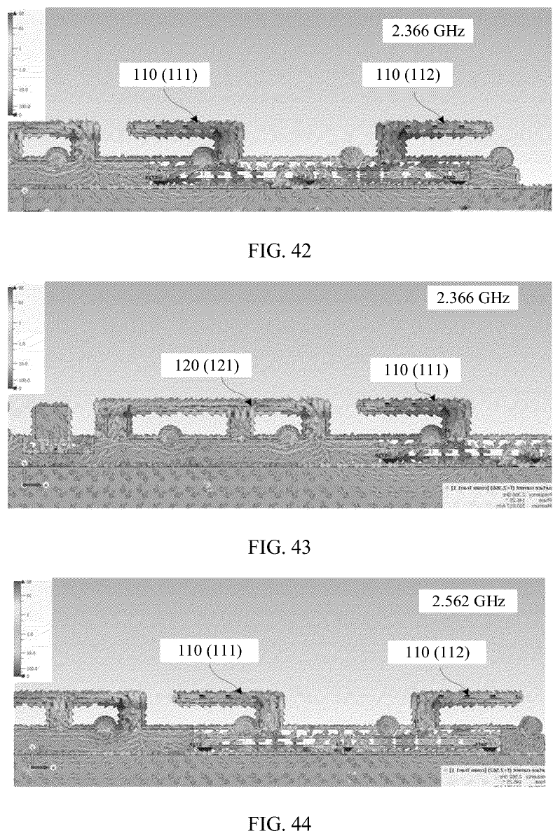

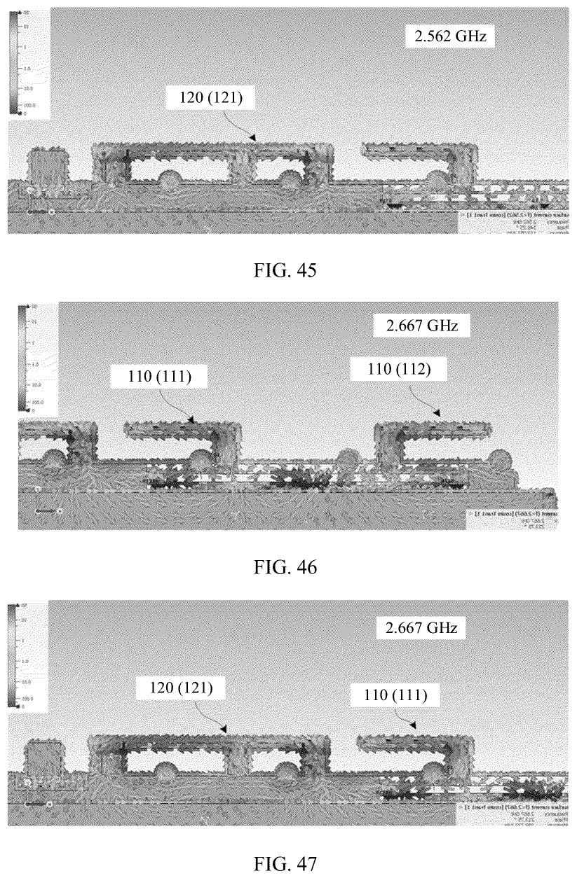

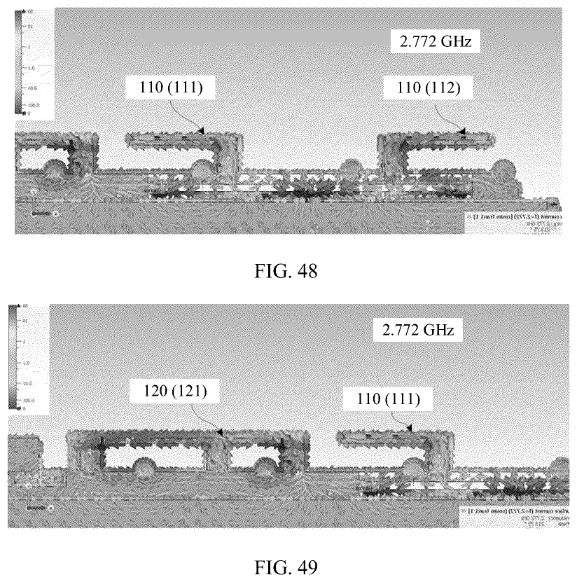

FIG. 42 to FIG. 49 show current distributions in an HF frequency band region in which the antenna structure 100 works at 2.366 GHz (as shown in FIG. 42 and FIG. 43), 2.562 GHz (as shown in FIG. 44 and FIG. 45), 2.667 GHz (as shown in FIG. 46 and FIGS. 47), and 2.772 GHz (as shown in FIG. 48 and FIG. 49). It can be learned from FIG. 42 to FIG. 49 that, in the HF frequency band range, a current on the third radiator 121 of the second antenna is basically equivalent to currents on the first radiator 111 and the second radiator 112 of the first antenna 110. It can be learned from a current distribution on the third radiator 121 of the second antenna 120 that the HF is produced through frequency tripling of the second antenna 120. Flow directions of the currents on the first radiator 111 and the second radiator 112 of the first antenna 110 are opposite and symmetric, and current distributions on the first transmission line 113 are opposite and symmetric. This forms a typical common-mode mode. To be specific, a working mode at the four HFs 2.366 GHz, 2.562 GHz, 2.667 GHz, and 2.772 GHz is a hybrid mode formed through superposition of frequency tripling of the second antenna 120 and a common mode of the first antenna 110.

In an embodiment of this application, when the second antenna 120 is switched, through the third switch 123, to work at different low frequencies such as LTE B8/B5/B12/B17/B28, an S11 curve at an LF, an MF, and an HF, antenna radiation, and system efficiency are shown in FIG. 28. It can be learned from FIG. 28 that a plurality of antenna resonances occur in a frequency band range of 0.6 GHz to 3 GHz. The antenna can work normally at the LF, the MF, and the HF. Each frequency is close to the central circle in the Smith circle diagram, which indicates that the antenna is well matched and has good performance.

According to the antenna structure 100 provided in this embodiment of this application, technical effects of total radiated power that are obtained when SARs in different frequency bands meet a regulatory requirement are shown in Table 2.

### Table 2 TRPs (Total Radiated Powers, Total Radiated Powers) in the Different Frequency Bands Obtained When the Sars Meet the Regulatory Requirement

Standard Frequency Antenna 5 mm-10 g SAR TRP (dBm) obtained when the band efficiency (dB) value (W/kg) SAR value is less than 1 W/kg

LTE B1 −2.7 1.32 19.30

B3 −2.8 1.51 18.70

B7 −3.8 1.5 17.70

B38 −3.3 1.43 18.20

B40 −3.8 1.25 18.70

B41 −3.6 1.44 17.90

WCDMA B1-2.7 1.32 19.30

B8-5.6 1.21 16.90

During a test, a conducted transmit power is 24.5 dBm. With reference to Table 2, when a 5 mm-10 g SAR in frequency bands such as LTE B1/3/7/38/40/41 and WB1/B8 is less than 1 W/kg, the TRP (total radiated power) can be greater than 16.9 dBm at a low frequency and greater than 17.7 dBm at a high frequency. A 3 db requirement on a high OTA performance indicator is met through a feature of a low SAR of the antenna structure 100. In addition, the 5 mm-10 g SAR values in the different frequency bands are all less than 2 W/kg (as required by a regulation). Therefore, according to the antenna structure 100 provided in this embodiment of this application, the low SAR is implemented by using a structural design of the first radiator 111 and the second radiator 112 in MF and HF operating bandwidths. An additional technology or component for example, fixed reduction of power of a hot point, antenna switching (Transmit Antenna Select, TAS), SAR reduction of a receiver, or a capacitive SAR sensor is not required. Therefore, in this embodiment of this application, a design of the low SAR at low costs is implemented.

Therefore, the antenna structure 100 provided in this embodiment of this application may be used in a terminal product that supports a plurality of LTE frequency bands, for example, a mobile phone, a tablet computer, or a PC. For a product that needs to meet a regulatory requirement on the SAR, low costs, the low SAR, and a high OTA performance indicator can be implemented. This improves actual communication experience of a user when the regulatory requirement is met.

An embodiment of this application further provides an electronic device. The electronic device may be a mobile or fixed terminal having the antenna structure 100, for example, a mobile phone, a tablet computer, a notebook computer, a smart home, a smart band, a smartwatch, a smart helmet, or smart glasses. Alternatively, the electronic device may be a handheld device that has a wireless communication function, a computing device, another processing device connected to a wireless modem, an in-vehicle device, an electronic device in a 5G network, an electronic device in a future evolved public land mobile network (PLMN), or the like.

In this embodiment of this application, an example in which the electronic device is a mobile phone is used for description. A part of a region of a metal frame of the electronic device may be used as radiators of the first antenna 110 and the second antenna 120. Alternatively, when a frame of the electronic device is a non-metal frame, radiators of the first antenna 110 and the second antenna 120 may be disposed on an inner side of the frame of the electronic device. By using the antenna structure 100, the electronic device supports simultaneous working in all LF, MF, and HF frequency bands, and a feature of a low SAR is implemented. In addition, locations of the first radiator 111, the second radiator 112, and the third radiator 121 can be flexibly arranged, so that the antenna structure of the electronic device is not limited to a fixed location. This ensures a more flexible antenna layout of the electronic device.

In the descriptions of embodiments of this application, it should be noted that, unless otherwise clearly specified and limited, the terms “installation”, “connection to”, and “connection” should be understood in a broad sense. For example, a connection may be a fixed connection, may be an indirect connection by using an intermediate medium, or may be an internal connection between two elements or an interaction relationship between two elements. For a person of ordinary skill in the art, specific meanings of the foregoing terms in embodiments of this application may be understood based on a specific situation.

An apparatus or element in embodiments of this application or an implied apparatus or element needs to have a specific direction and be constructed and operated in a specific direction, and therefore cannot be construed as a limitation to embodiments of this application. In the descriptions of embodiments of this application, “a plurality of” means two or more, unless otherwise precisely and specifically specified.

In the specification, claims, and accompanying drawings of embodiments of this application, the terms “first”, “second”, “third”, “fourth”, and so on (if existent) are intended to distinguish between similar objects but do not necessarily indicate a specific order or sequence. It should be understood that data termed in such a way is interchangeable in an appropriate circumstance so that embodiments of this application described herein can be implemented in other orders than the order illustrated or described herein. In addition, the terms “include” and “have” and any other variants thereof are intended to cover the non-exclusive inclusion. For example, a process, method, system, product, or device that includes a list of steps or units is not necessarily limited to those expressly listed steps or units, but may include other steps or units not expressly listed or inherent to such a process, method, product, or device.

The term “a plurality of” in this specification means two or more. The term “and/or” in this specification describes only an association relationship between associated objects and indicates that three relationships may exist. For example, A and/or B may indicate the following three cases: Only A exists, both A and B exist, and only B exists. In addition, the character “/” in this specification generally indicates an “or” relationship between associated objects. In a formula, the character “/” indicates a “division” relationship between associated objects.

It may be understood that various numbers in embodiments of this application are merely used for differentiation for ease of description, and are not used to limit the scope of embodiments of this application.

It should be understood that sequence numbers of the foregoing processes do not mean execution sequences in embodiments of this application. The execution sequences of the processes should be determined based on functions and internal logic of the processes, and should not be construed as any limitation on the implementation processes of embodiments of this application.

1. An antenna structure, comprising a first antenna, a second antenna, and a feeding point, wherein
the first antenna comprises a first radiator, a second radiator, a first transmission line, a first matching circuit, and a second matching circuit;
the first transmission line has an intersection point, a first connection point, and a second connection point, the intersection point is electrically connected to the feeding point, one end of the first radiator is electrically connected to the first connection point, one end of the second radiator is electrically connected to the second connection point, and the other end of the first radiator and the other end of the second radiator are separately disposed in an extension manner in directions that are away from each other;
the first radiator and the second radiator are symmetric relative to a perpendicular bisector of a line between the first connection point and the second connection point, and the intersection point is located on the perpendicular bisector;
one end of the first matching circuit is electrically connected to the first transmission line located on a side of the perpendicular bisector on which the first connection point is located, and the other end of the first matching circuit is grounded;
one end of the second matching circuit is electrically connected to the first transmission line located on a side of the perpendicular bisector on which the second connection point is located, and the other end of the second matching circuit is grounded; and
the second antenna comprises a third radiator and a second transmission line, one end of the second transmission line is electrically connected to the feeding point, the other end of the second transmission line is electrically connected to one end of the third radiator, and the other end of the third radiator is grounded.

2. The antenna structure according to claim 1, wherein the second matching circuit is the same as the first matching circuit, and the second matching circuit and the first matching circuit are symmetrically disposed relative to the perpendicular bisector.

3. The antenna structure according to claim 1, wherein the first matching circuit comprises a first capacitor and a first inductor, the first capacitor and the first inductor are disposed in parallel, one end of the first capacitor and one end of the first inductor are both electrically connected to the first transmission line on the side on which the first connection point is located, and the other end of the first capacitor and the other end of the first inductor are both grounded.

4. The antenna structure according to claim 3, wherein the second matching circuit comprises a second capacitor and a second inductor, the second capacitor and the second inductor are disposed in parallel, one end of the second capacitor and one end of the second inductor are both electrically connected to the first transmission line located on the side on which the second connection point is located, and the other end of the second capacitor and the other end of the second inductor are both grounded.

5. The antenna structure according to claim 4, wherein the first capacitor and the second capacitor are axially symmetrically disposed relative to the perpendicular bisector; and
the first inductor and the second inductor are symmetrically disposed relative to the perpendicular bisector.

6. The antenna structure according to claim 1, wherein the first transmission line comprises a first branch transmission section and a second branch transmission section, the first connection point is located in the first branch transmission section, and the second connection point is located in the second branch transmission section; and
one end of the first branch transmission section and one end of the second branch transmission section are both electrically connected to the intersection point, and the other end of the first branch transmission section and the other end of the second branch transmission section are respectively electrically connected to the first matching circuit and the second matching circuit.

7. The antenna structure according to claim 6, wherein the first transmission line further comprises a general transmission section, one end of the general transmission section is electrically connected to the feeding point; and the other end of the general transmission section, one end of the first branch transmission section, and one end of the second branch transmission section intersect to form the intersection point.

8. The antenna structure according to claim 1, wherein the first connection point, the second connection point, and the intersection point are located on a same straight line.

9. The antenna structure according to claim 1, wherein an included angle between a connection line between the first connection point and the intersection point and a connection line between the second connection point and the intersection point exists on the first transmission line.

10. The antenna structure according to claim 1, wherein the first antenna further comprises a first switch, and the first switch is located on a connection link between the first radiator and the first connection point.

11. The antenna structure according to claim 1, wherein the first antenna further comprises a second switch, and the second switch is located on a connection link between the second radiator and the second connection point.

12. The antenna structure according to claim 1, wherein the second antenna further comprises a third switch, one end of the third switch is electrically connected to the third radiator, and the other end of the third switch is grounded, or the other end of the third radiator is grounded through the third switch.

13. The antenna structure according to claim 1, further comprising a circuit board, wherein the first transmission line, the second transmission line, the first matching circuit, the second matching circuit, and the feeding point are all located on the circuit board; and
the first radiator, the second radiator, and the third radiator are located on an outer side of an edge of the circuit board.

14. The antenna structure according to claim 13, wherein the first radiator, the second radiator, and the third radiator are located on a same side of an outer edge of the circuit board; and
the first radiator is located between the second radiator and the third radiator; or
the second radiator is located between the first radiator and the third radiator.

15. The antenna structure according to claim 13, wherein the first radiator and the second radiator are respectively located on two adjacent sides of the circuit board.

16. The antenna structure according to claim 1, wherein the first radiator and the second radiator each comprise a first vertical stub and a first horizontal stub, and one end of the first vertical stub is electrically connected to the first horizontal stub.

17. The antenna structure according to claim 16, wherein the first radiator and the second radiator each further comprise a second vertical stub, one end of the second vertical stub is electrically connected to the first horizontal stub, and the other end of the second vertical stub faces the first transmission line.

18. The antenna structure according to claim 17, wherein the first radiator and the second radiator each further comprise a second horizontal stub, one end of the second horizontal stub is electrically connected to the second vertical stub, the other end of the second horizontal stub faces the first vertical stub, and there is a space between the other end of the second horizontal stub and the first vertical stub.

19. The antenna structure according to claim 1, wherein the third radiator comprises a third horizontal stub, a third vertical stub, and a fourth vertical stub, one end of the third vertical stub and one end of the fourth vertical stub are electrically connected to the third horizontal stub, the other end of the third vertical stub is electrically connected to the second transmission line, and the other end of the fourth vertical stub is grounded.

20. The antenna structure according to claim 19, wherein the third radiator further comprises a fifth vertical stub, the fifth vertical stub is located between the third vertical stub and the fourth vertical stub, one end of the fifth vertical stub is electrically connected to the third horizontal stub, and the other end of the fifth vertical stub is grounded.
